(19) United States
(12) Patent Application Publication
(10) Pub. No.: US 2012/0295623 A1
(43) Pub. Date: Nov. 22, 2012

(54) METHODS AND APPARATUSES FOR POSITIONING A NODE IN A WIRELESS COMMUNICATIONS SYSTEM USING DIFFERENT RAN/RATS

(75) Inventors: Iana Siomina, Solna (SE); Torbjörn Wigren, Uppsala (SE); Ari Kangas, Lidingo (SE)

(73) Assignee: TELEFONAKTIEBOLAGET LM ERICCSSON (publ), Stockholm (SE)

(21) Appl. No.: 13/575,168

(22) PCT Filed: Sep. 24, 2010
(86) PCT No.: PCT/SE10/51028

§ 371 Date: Jul. 25, 2012

Related U.S. Application Data
(60) Provisional application No. 61/303,377, filed on Feb. 11, 2010.

(51) Int. Cl. H04W 64/00; H04W 36/16

(52) U.S. Cl. 455/436; 455/456.2

(57) ABSTRACT

A method in a positioning node (100) for selecting a positioning method is provided. The positioning node is connected to a plurality of radio access networks of different access technologies and to a plurality of core networks. The positioning node receives (201) from a requesting node, a request for a positioning of a terminal. The request comprises at least one of a plurality of client types, and at least one of a plurality of quality of service parameters. The positioning node then selects (204) at least one positioning method of a plurality of positioning methods of the different plurality of radio access networks and or radio access technologies for positioning the terminal. The selection of the positioning method is based on the received at least one client type and at least one quality of service parameters of the request.

### TECHNICAL FIELD

The present invention relates to a positioning node, a method in positioning node, a terminal and a method in a terminal. In particular, it relates to improvements of selecting a positioning method and handling a positioning of the terminal.

### BACKGROUND

In a typical cellular radio system, also referred to as a wireless communication system, User Equipments (UEs), also known as mobile terminals and/or wireless terminals communicate via a Radio Access Network (RAN) to one or more core networks (CNs). The UEs may be mobile telephones also known as “cellular” telephones, or laptops with wireless capability, e.g., mobile termination, and thus may be, for example, portable, pocket, hand-held, computer-included, or car-mounted mobile devices which communicate voice and/or data with radio access network.

The radio access network covers a geographical area which is divided into cell areas, with each cell area being served by a base station, e.g., a Radio Base Station (RBS), which in some networks is also called “eNB”, “eNodeB”, or “NodeB”, which can be of different classes e.g. macro eNodeB or home eNodeB or pico base station, and which in this document also is referred to as a base station. The base stations communicate over the air interface operating on radio frequencies with the user equipment units within range of the base stations.

In some versions of the radio access network, several base stations are typically connected, e.g., by landlines or microwave, to a Network Controller, e.g. Radio Network Controller (RNC) in Universal Mobile Telecommunications System (UMTS) or Base Station Controller (BSC) in GSM, which supervises and coordinates various activities of the plural base stations connected thereto. In Long Term Evolution (LTE), eNodeBs may be connected to a gateway e.g. radio access gateway. The radio network controllers are typically connected to one or more core networks.

The UMTS is a third generation (3G) mobile communication system, which evolved from the second generation (2G) Global System for Mobile Communications (GSM), and is intended to provide improved mobile communication services based on Wideband Code Division Multiple Access (WCDMA) access technology. UMTS Terrestrial Radio Access Network (UTRAN) is essentially a radio access network using wideband code division multiple access for user equipment units (UEs). The Third Generation Partnership Project (3GPP) has undertaken to evolve the UTRAN and GSM based radio access network technologies further, resulting in the 3GPP LTE which is the next generation of cellular networks which further evolves to LTE-Advanced.

A variety of Radio Access Technologies (RATs) that currently exist or being standardized resulted in practice in deploying networks with different co-existing RATs, e.g. RANs that may use different RATs such as GSM, Code Division Multiple Access 2000 (CDMA2000), WCDMA and LTE. Positioning and Location Services (LCS) support for LTE are currently being standardized, while focusing on single-RAT LCS support.

Some inter-RAT measurements exist, e.g. inter-RAT signal strength or signal quality measurements. However, they are originally defined for other purposes than for LCS, even though potentially they can also be used for LCS.

Presently available and known positioning technology is based on positioning method selection mechanisms and associated signaling means that operate within one single RAN and/or limited to either control- or user-plane solution each of which may have own sets of available positioning methods and measurements. Such single-RAT single-plane technical solutions have at least the following drawbacks and problems associated with them:
The statistical availability of positioning results available to the user is not so good.
The statistical accuracy of positioning results available to the user within a single RAT may be low.
The cost of purchase, maintenance and operation for operators to maintain a positioning functionality at a specific quality in each specific RAN, is rather high.
The performance of user plane positioning is dependent on positioning information available in the terminal and thus may have a performance that is not so good.

A possible implementation of single-RAT position method selection in WCDMA will now be described.

The UE Positioning function, where a a UE is considered to be a terminal in the WCDMA Radio Network Controller (RNC) is controlled by means of operator configurable sets of logic for positioning method selection. The notation “positioning method selection algorithm” will be used below. The inputs to the positioning method selection algorithm comprises:
A Client Type, received in a LOCATION REPORTING CONTROL message.
A Quality of Service (QoS) parameters such as Response Time, Accuracy Code and Vertical Accuracy Code, received in a LOCATION REPORTING CONTROL message.
An Enabled Positioning Features parameter.
An UE Capability, primarily to reveal the assisted GPS (A-GPS) capability of the UE.

In a first revision of a QoS discriminating positioning feature, three service classes are implemented, with one configurable set of selection logic for each service class. Each service class is defined by configured Client Types, eight Client Types are defined in WCDMA . There is one client type for emergency positioning and two service classes for different commercial services. The Emergency Services class is the default one.

A logic for each service class allows a first positioning attempt, possibly followed by two re-attempted positioning attempts. The following alternatives are configurable by an operator:
Valid for all service classes:
   The typical QoS for each licensed positioning method, including
      Typical response time,
      Typical Accuracy Code, Horizontal accuracy expressed as a radius,
      Typical Vertical Accuracy Code, Vertical accuracy.
Valid for each service class, separately:
   A list of Client Types, for which the service class shall be selected.
   It should be noted that a Client Type is only allowed to appear in one service class. Furthermore, no list is needed for the Emergency Services service class, which is the default case.
   Valid for all positioning attempts
      Selection of post-check of QoS after each positioning attempt. Note that the QoS is not computed unless a post check is configured.
   First Positioning attempt
      An ordered list of selectable positioning methods,
      The method with best QoS is selected.
   Second positioning attempt:
      Hard selection of first re-attempted positioning method, from list of selectable positioning methods.
   Note: In this prior art, a positioning method that has already been executed is not executed a second time.
   Third positioning attempt:
      Hard selection of second re-attempted positioning method, from list of selectable positioning methods.
      It should be noted that in this prior art, a positioning method that has already been executed is not executed a second time.

The positioning selection algorithm operates by first checking a Client Type Information Element (IE) that is received in a LOCATION REPORTING CONTROL message. The Client Type will then correspond to the appropriate service class. The positioning method selection algorithm then proceeds by selection of a first positioning method. This selection is QoS-based, and accounts for
The requested QoS, as received in the LOCATION REPORTING CONTROL message,
The configured typical Response Time, Accuracy Code i.e. Horizontal accuracy and Vertical Accuracy Code i.e. Vertical accuracy, for each of the licensed positioning methods,
The UE Capability and the enabledPositioningFeatures parameter, which determines if the positioning method is turned on in a Radio Network Subsystem (RNS).

The selection algorithm loops over the whole list of configured possible first positioning methods, and selects the method that best meets the QoS criteria. The precedence of the QoS criteria follows 3GPP, i.e. Response Time, Accuracy Code followed by Vertical Accuracy Code. In case two methods are equally good, the first method of the list of configured possible first positioning methods is selected.

After the first positioning method has been selected (selection of no method is a possibility), the selected positioning method is executed.

If configured, a post check of the achieved accuracy is performed, after which it is determined if the UE Positioning function shall proceed with reporting or re-attempted positioning, depending of the outcome of the test. In case of failure of the selected positioning method the UE Positioning method also proceeds with re-attempted positioning.

In case the UE Positioning function proceeds with re-attempted positioning, the UE Capability and enabledPositioningFeatures are checked, this time for the positioning method which is configured for the second positioning attempt. If the test is successful, this positioning method is executed. At completion any configured post check is performed to check the achieved accuracy. If the achieved accuracy fulfils the requested accuracy, the result of the second positioning attempt is reported, otherwise a third positioning attempt is performed. A third positioning attempt is also performed in case the second positioning attempt would fail.

The third attempt operates like the second attempt, with the exception that after completion, no post check needs to be performed. The reason is that there is no fourth attempt in case the achieved QoS would not be good enough. For the same reason, the UE Positioning function reports the result of the positioning attempt that best meets the requested QoS, as received in the LOCATION REPORTING CONTROL message.

Positioning service, LCS and location-based services (LBS) are becoming more and more important to cellular operators. Presently, the introduction of smart phones offers new service possibilities that will require operators to optimize performance, with respect to positioning requirements for different services.

### SUMMARY

It is therefore an object of embodiments of the present solution to provide a method and arrangement for improving the performance of the positioning methods.

According to an aspect, the object is achieved by a method in a positioning node for selecting a positioning method. The positioning node is connected to a plurality of radio access networks of different access technologies and to a plurality of core networks. The positioning node receives from a requesting node, a request for a positioning of a terminal. The request comprises at least one of a plurality of client types, and at least one of a plurality of quality of service parameters. The positioning node then selects a positioning method of a plurality of positioning methods of the different plurality of radio access networks and or radio access technologies for positioning the terminal. The selection of the positioning method accounts for the at least one client type and the at least one quality of service parameters received in the request.

According to another aspect, the object is achieved by means of a positioning node for selecting a positioning method. The positioning node is arranged to be connected to a plurality of radio access networks of different access technologies and to a plurality of core networks. The positioning node comprises signalling means configured to receive from a requesting node, a request for a positioning of a terminal. The request comprises at least one of a plurality of client types, and at least one of a plurality of quality of service parameters. The positioning node further comprises a positioning method selecting unit configured to select at least one positioning method of a plurality of positioning methods of the different plurality of radio access networks and or radio access technologies for positioning the terminal. The selection of the positioning method accounts for the at least one client type and at least one quality of service parameters received in the request.

According to a further aspect, the object is achieved by a method in a terminal for handling positioning of the terminal. The terminal is configured to access a plurality of radio access networks of different access technologies for performing positioning measurements. The terminal is camping on a first radio access network. The first radio access network is comprised in the plurality of radio access networks comprising the respective positioning technologies and further comprising at least one second radio access network. According to the method, the terminal receives a request from a positioning node to perform positioning measurements according to a positioning method, while involving inter-radio access technology measurement, The terminal then performs positioning measurements at least in the second radio network, and the terminal transmits, to the positioning node, the positioning measurements comprising at least the measurements performed in the second radio network, enabling the positioning node to determine the position of the terminal.

According to a further aspect, the object is achieved by means of a terminal for handling positioning of the terminal. The terminal is configured to access a plurality of radio access networks of different access technologies for performing positioning measurements: The terminal is camping on a first radio access network. The first radio access network is comprised in the plurality of radio access networks comprising the respective positioning technologies and further comprising at least one second radio access network. The terminal comprises a receiver configured to receive a request from a positioning node to perform positioning measurements according to a positioning method, while involving inter-radio access technology measurements. The terminal further comprises a processor configured to perform positioning measurements at least in the second radio network. The terminal further comprises a transmitter configured to transmit the positioning measurements to the positioning node comprising at least the measurements performed in the second radio network. This enables the positioning node to determine the position of the terminal.

An advantage with embodiments of the present solution comprises an enhanced positioning availability and an enhanced positioning accuracy, since the best result could be determined from more than one radio access network and/or more than one positioning solution realization.

Another advantage with embodiments of the present solution, for an operator and/or network provider, comprises a reduced need to purchase, maintain and operate positioning technology for each of the radio access technologies (RATs). the operator or provider bases its business on, involving significant cost reductions, and a possibility to optimize the positioning performance of all its RATs, by selection of positioning technology of a certain kind from the RAT that provides the best performance for said kind of positioning technology. This provides a way to maximize performance with a much reduced investment, as compared to today's situation.

A further advantage with embodiments of the present solution is that it provides a potential to improve the general performance of user plane positioning.

### BRIEF DESCRIPTION OF THE DRAWINGS

The present solution is described in more detail with reference to attached drawings illustrating exemplary embodiments of the invention and in which:

FIG. 1 is a schematic block diagram illustrating embodiments of the present solution.

FIG. 2 is a flowchart depicting embodiments of a method.

FIG. 3 is a schematic block diagram illustrating embodiments of the present solution.

FIG. 4 is a schematic block diagram illustrating embodiments of a positioning node.

FIG. 5 is a schematic signalling diagram illustrating a message sequence used in a circuit switched domain on the A interface, GSM.

FIG. 6 is a schematic signalling diagram illustrating a message sequence used in a packet switched domain over the Gb interface, GSM.

FIG. 7 is a schematic block diagram illustrating the positioning architecture in CDMA2000.

FIG. 8 is a schematic block diagram illustrating positioning architecture and protocols in E-UTRAN, control plane.

FIG. 9 is a schematic signalling diagram illustrating LPP Location Information Transfer procedure between a UE and E-SLMC.

FIG. 10 is a schematic signalling diagram illustrating Location Service Support by E-UTRAN for positioning a target UE.

FIG. 11 is a schematic signalling diagram illustrating procedures when a LCS service request is initiated by an eNodeB.

FIG. 12 is a flowchart depicting embodiments of a method.

FIG. 13 is a schematic block diagram illustrating embodiments of a terminal.

### DETAILED DESCRIPTION

Positioning and LoCation Service (LCS) support for LTE are currently being standardized and, the focus has been on LCS support within LTE only, however, there are advantages with a fully integrated multi-radio access technology (RAT) approach for positioning, which embodiments herein provides. Embodiments herein disclose means for positioning method selection, in a multi-RAT environment.

Embodiments herein also disclose signaling means in support of this positioning method selection and LCS in a multi-RAT environment.

Furthermore, in the near future more satellite navigation systems than GPS will become available. 3GPP has defined joint satellite positioning functionality denoted Assisted Global Navigation Satellite System (A-GNSS), to be used when that occurs. Embodiments herein are valid also for this case, i.e. not restricted to Assisted GPS (A-GPS) but also apply to A-GNSS. The majority of the description does however use A-GPS since this is a current industry standard.

Today, a majority of cell phones e.g. smart phones also referred to here as terminals handle multiple RATs. The consequence for positioning technology of embodiments herein is that the terminal may derive a position based on positioning technology in more than one RAT/RAN, i.e. on a plurality of RATs/RANs. The benefit for the end user of the terminal comprises an enhanced availability and an enhanced accuracy since the best result could be determined from more than one radio access network.

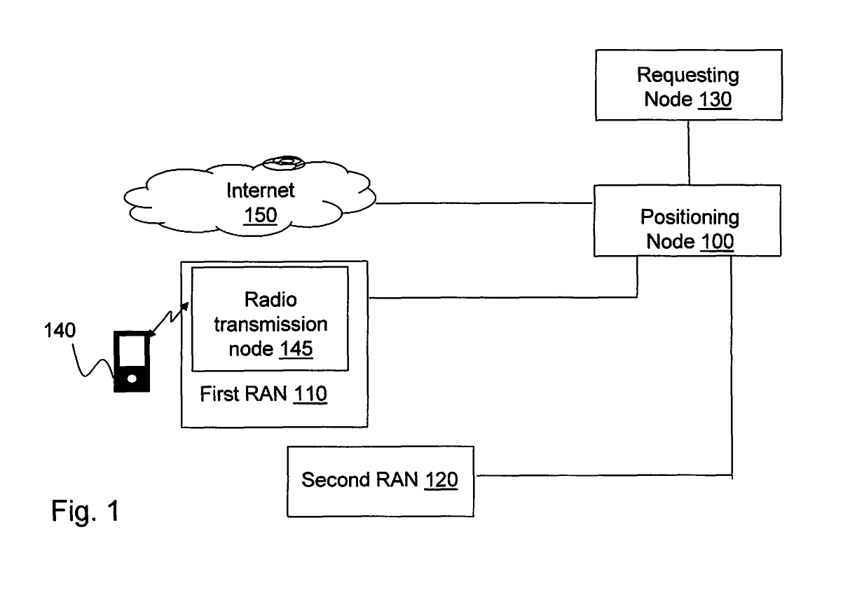

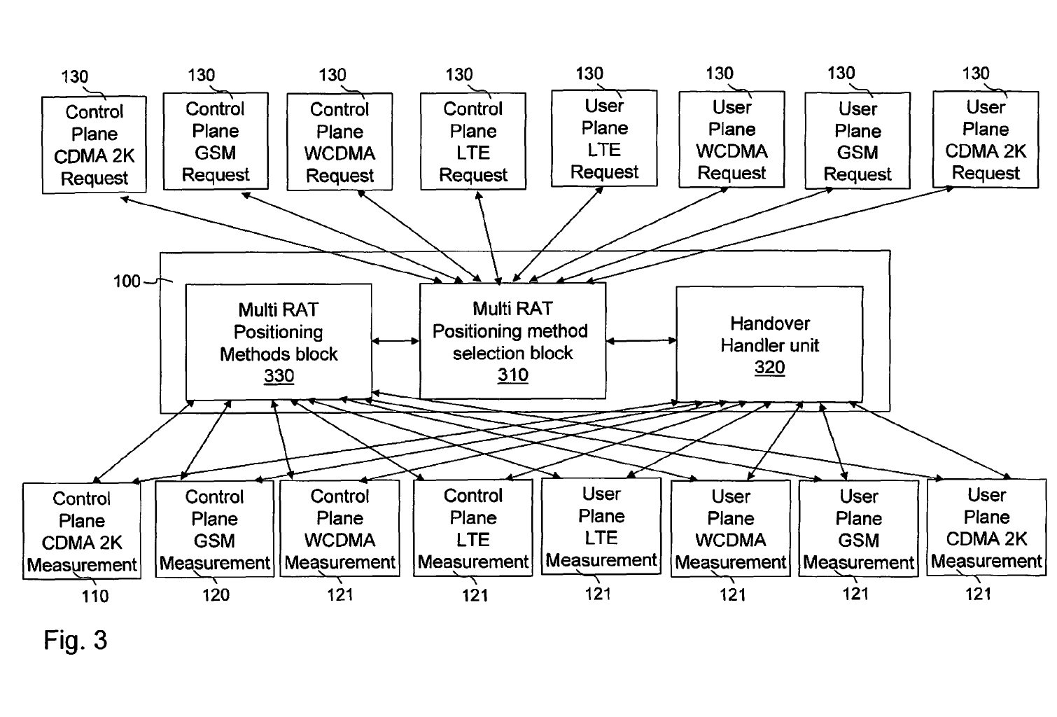

FIG. 1 depicts a positioning node 100 in which exemplary embodiments herein may be implemented. More and more of the traffic goes to a user plane. The positioning node 100 may in some embodiments be a user plane positioning server, i.e. a positioning node of a user plane. The positioning node 100 is configured to be connected to a plurality of radio access networks of different access technologies. The connections may be over physical direct links or may be logical e.g. via higher-layer protocols. For simplicity, only two radio access networks are shown In FIG. 1, a first radio access network 110 and a second radio access network 120, which are here considered to belong to different radio access technologies. Further examples of these radio access networks are depicted in FIG. 3, referred to as reference number 121. These radio networks of different access technologies may e.g. be user plane CDMA 2000, user plane GSM, user plane WCDMA, user plane LTE, control plane CDMA 2000, control plane GSM, control plane WCDMA, control plane LTE or any other radio access network. Also, LTE Frequency Division Duplex (FDD) and LTE Time Division Duplex (TDD) may also be considered to be different RATs. Note that here user plane and control plane positioning may also count as different RANs/RATs. By “LTE” is also meant evolutions of the LTE technology, e.g. LTE-Advanced.

FIG. 1 further depicts a requesting node 130, which is a node that requests for a positioning of a terminal 140. The positioning node 100 has signalling means for communicating with requesting entities such as the requesting node 130. In FIG. 1 only one requesting entity, i.e. the requesting node 130 is shown for simplicity. The requesting node 130 may e.g. be one of a core network node, the terminal 140 or an emergency centre. In the example of FIG. 1 the requesting node is a core network node. The terminal 140 is comprised in the first radio access network 110. The word “terminal” is a general terminology used herein for generalization purpose to denote a device or node being positioned. The terminal 140 may be a mobile phone such as a UE, a base station, a Mobile Station (MS), a small base station or any other node that may be a positioning target. The terminal in FIG. 1 is a mobile phone which communicates with the first radio access network 110 via a radio transmission node 145 comprised in the first radio access network 110.

In some embodiments the positioning node 100 may be connected to the internet 150.

In at least one exemplary embodiment, the positioning node 100 may be in a core network. In another non-limiting exemplary embodiment, the positioning node 100 may be an entity in the terminal when the terminal performs positioning of itself, e.g. corresponding to UE-based positioning when the terminal is a UE. In this case, the plurality of core networks to which the positioning node is connected may be empty. In yet another embodiment, the terminal may also request positioning of itself and thus the requesting node is an entity in the terminal.

Embodiments herein disclose technology that comprises:

1. New functionality for multi-RAT positioning method selection.

2. New signalling means in support of the new functionality for multi-RAT positioning method selection.

3. A positioning multi-RAT architecture concept.

4. New functionality for configuring multi-RAT positioning measurements.

Embodiments herein disclose technology that:

A•Enables Positioning Method Selection
A1. Accounting for service class, LCS client type and QoS information in requests from the requesting node 130, said requesting node 130 being a core network node, a node operating in multiple RANs 110, 120 exploiting different RATs, or an external node, e.g. on the internet. A request may also come from a UE. Here user plane and control plane positioning may count as different RANs/RATs 110, 120.
A2. Using radio measurements on different RANs 110, 120 exploiting different RATs, going beyond standard inter-RAT measurements, said radio measurements on different RANs comprising e.g. timing advance (TA) and round trip time (RTT) and timing measurements, e.g. time of arrival or time difference of arrival, and signal strength or signal quality measurements performed on a positioning request.
   Embodiments herein also disclose technology that:

B•Defines signaling means such as signaling interfaces and protocols (new or extended ones), higher-layer protocols or lower-layer protocols for messages and information elements in the messages.
B1. Between a positioning node 100 and a requesting node 130. The requesting node 130 being a part of a core network, entities/ nodes operating in multiple RANs 110, 120 exploiting different RATs. The signaling means transfers service class, client type and QoS information between said nodes i.e. between the requesting node 130, and said positioning node 100. Also, signaling support for multi-RAT capability transfer, where multi-RAT capability may be general multi-RAT capability of the entity or positioning-specific capability of the entity.
B2. Between the positioning node 100 and a radio transmission node 145. The radio transmission node 145 may be a base station, remote radio unit, relay node, etc., typically an eNB in LTE within the RANs 110, 120. The positioning node 100 has functionality for transmitting and receiving signalling messages to and from transmitting and receiving nodes in multiple RATs 110, 120. The signaling means has functionality for requesting and delivering assistance information, capability exchange, positioning measurements and positioning results. The contents and the origin of the said assistance information depends on the positioning method, capabilities of the network and device being positioned. The assistance information is transmitted by the positioning node 110 to terminal 140 to assist and help it with measurement. The assistance information comprises information enhancing the performance of the terminal 140 when performing positioning measurements. The positioning node 100 may build up the assistance information based on the information received from at least one of: internet 150, where it may be collected by GPS reference receivers e.g. for A-GPS assistance information to be sent to the terminal, from RANs 110, 120, e.g. configuration of reference signals and their transmit occasions, from requesting node 130, e.g. client type or positioning QoS requirements, and terminal 140, e.g. the terminal capabilities. Other examples of assistance data are A-GPS assistance data such as satellite trajectory models, as well as timing information informing the terminal where to search in the time and doppler window. Also, cover signaling support for multi-RAT capability transfer or exchange, where multi-RAT capability may be general multi-RAT UE or radio node capability or positioning-specific UE or radio node capability.
B3. Between said positioning node 100 and the terminal 140. The terminal 140 has functionality for accessing multiple RANs 110, 120 exploiting multiple RATs. The signaling means carry position measurement requests or multi-RAT capability requests, where multi-RAT capability may be general terminal capability or positioning-specific terminal capability, from the positioning node 100 to the terminal 140. Note that this may be performed over the control plane or over the user plane.
B4. Assistance data transmitted from the positioning node 100 to the terminal 140. In embodiments herein, the assistance data for multi-RAT positioning measurements comprises data for cells which belong to a single RAN/RAT and thus multiple batches, one per RAN/RAT, of the assistance data may be envisioned. In other embodiments, the assistance data for multi-RAT positioning measurement comprise the assistance data for cells where at least two cells belong to different RAN/RATs, where the assistance data may be transmitted in a single batch. Positioning result obtained based on measurements may be conducted in multiple RATs/RANs 110, 120 and transmitted from the positioning node 100 to the terminal 140.
B5. Between said terminal 140 and said positioning node 100, said signaling means for multi-RAT capability transfer or exchange, where multi-RAT capability may be general terminal capability or positioning-specific terminal capability. Today with single RAT positioning, the positioning node 100 does not know of the capabilities of a terminal in other RATs when it comes to positioning services. Hence, according to an embodiment, new capability information elements are provided, signalling the details of this capability to the positioning node 100. This is an advantage since otherwise the positioning node will not try positioning methods in other RANs that could potentially improve the result. As an example, if the terminal 140 is on LTE, today's technology does not signal the capability on positioning in e.g. WCDMA.
B6. Between said terminal 140 and said positioning node 100, said signaling means carrying position measurement results from said terminal to said positioning node 100. Note that this may be performed over the control plane or over the user plane. In one embodiment, a measurement report comprises measurements performed on a single RAN/RAT. In this case multiple measurement reports may be transmitted by the terminal 140 and expected to be received by the positioning node 100 when multi-RAT measurements are performed or requested to be performed. In other embodiments, a measurement report comprises measurements from multiple RAN/RATs.
B7. Between said positioning node 100 and said requesting entities such as the requesting node 130, said signaling means carrying position results based on multi-RAT measurements from said positioning node 100 to said requesting entities.
B8. Between said radio transmission node 145 and said terminal 140 the signaling of broadcasted assistance data where the assistance data comprise the information about cells and at least two cells in the assistance data belong to different RAN/RATs.
B9. Between said positioning node 100 and said radio transmission node 145, signaling of the information for the assistance data to be broadcasted, e.g. as described in 8 above.
B10. Between said radio transmission node 145 and positioning node 100, signaling of a request for the information for the multi-RAT assistance data to be broadcasted, e.g. as described in B8 above.
B11. Between said positioning node 100 and said radio transmission node 145, signaling of the request for the information to be used for building up by the positioning node 100, the assistance information to be sent to terminal 140 by the said positioning node 100.
B12. Between said radio transmission node 145 and positioning node 100, signaling of the information to be used for building up by the said positioning node the assistance information to be sent to terminal 140 by the said positioning node
B13. Any signaling with reported positioning measurements where the measurement report is a multi-RAT positioning measurement report using a generalized format for reporting measurements obtained in different RATs. In some embodiments the positioning measurement report may comprise measurements from at least two different RATs, and in some embodiments the generalized report format comprises a format different from that which may be used for reporting measurements for positioning involving only one of the plurality of RATs/RANs.
B14. Any signaling for transmitting the positioning result where the position report with said positioning result is in a generalized format used for reporting multi-RAT positioning result. In some embodiments said format may be different from that used for single-RAT measurements and in that case a conversion e.g. shape conversion may be applied to convert between a single-RAT positioning result format and the said multi-RAT positioning result format.
B15. Any signaling for transmitting the service class and the client type information. In some embodiments said service class and said client type information are from a common set of service classes and common set of client types where each client type and/or service class supported by at least one of the plurality of RATs/RANs, i.e. those supported with multi-RAT positioning, has at least one corresponding client type and/or service class in the corresponding generalized set. In some embodiments, extended sets of service classes and client types are defined for multi-RAT positioning, wherein an extended set may be larger than the union of the currently defined sets for single-RAT positioning.
B16. Between said radio transmission node 145 and said positioning node 100 transmission of request for measurements from the said positioning node to said radio transmission nodes, and transmissions of the measurement results conducted by radio transmission nodes that belong to RATs/RANs 110, 120 to the positioning node. Examples of said measurements are receive-transmit time or angle of arrival measured at a radio transmission node,

Embodiments herein also disclose technology that:

C•Combines said positioning measurement results obtained from different RANs exploiting different RATs, into a combined position of the terminal 140, said combining being performed in the positioning node 100. A special case of this is that user plane positioning may be augmented by control plane position information retrieved even from another RAN/RAT.

Note also that by said terminal 140 that is being positioned is meant, also a Base Station or any other access point as well as a user equipment that is being positioned, may be interpreted in this case as a terminal if they have the corresponding functionality. Meaning that not only terminals that may be a positioning target, but also e.g. a small base station, etc. may be a terminal to be positioned.

Embodiments herein disclose technology comprising:

D. Functionality for configuring multi-RAT positioning measurements.

Configuring positioning measurements may be based on the received multi-RAT capability. The configuring of positioning measurements comprises at least one of the below:
D1. A possibility to include the RAN/RAT information for cells in the assistance data;
D2. Configuring multi-RAT positioning assistance data transmitted from positioning node 100 to the terminal 140, where the multi-RAT positioning assistance data comprises information about at least two cells operating in different RAN/RATs;
D3. Configuring measurement gaps for multi-RAT positioning measurements when the terminal 140 is not capable of performing multi-RAT measurements without measurement gaps where the gaps in some embodiments are configured by the radio transmission node 145;
D4. Configuring handover for a purpose of positioning measurements;
D5. Triggering handover for a purpose of positioning measurements. This implies signalling between the positioning node 100 and network nodes in RATs 110, 120 responsible for mobility e.g. eNodeB and MME in LTE.

The above discussion has been focused on so called control plane positioning. However, in parallel, user plane positioning has been developed. That technology uses a data link between the terminal 140 and the positioning node 130 that is transparent to the nodes that manage the data link transmission between the terminal and the positioning node. The user plane positioning emulates the control plane signalling between the positioning node 100 and the terminal 140, thereby removing the need for positioning functionality in the RANs.

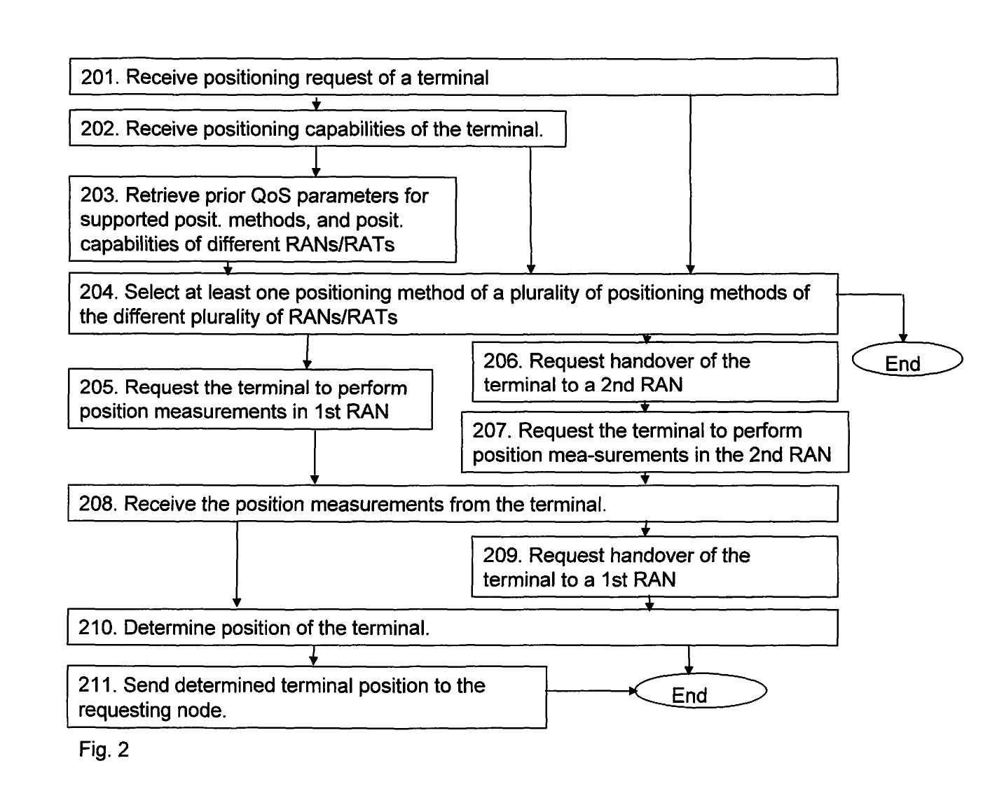

The present solution relating to a method in the positioning node 100 for selecting a positioning method, according to some embodiments which will now be described with reference to the flowchart depicted in FIG. 2. As previously described the positioning node 100 is connected to a plurality of RANs 110, 120, 121 of different radio access technologies (RATs) and to a plurality of core networks. The method comprises the following steps, which steps may as well be carried out in another suitable order than described below. The described sequence of steps is a non-limiting example of the method implementation.

Step 201

The positioning node 100 receives from the requesting node 130, a request for a positioning of a terminal 140. The request comprising at least one of a plurality of client types, and at least one of a plurality of quality of service parameters. This is related to point B1 above.

In some embodiments, the QoS parameters may e.g. be Response Time, Accuracy Code and Vertical Accuracy Code. According to one embodiment, in the QoS discriminating positioning feature, three service classes are implemented, with one configurable set of selection logic for each service class. Each service class, except the Emergency Services class may be set to default, is defined by configured Client Types. There may be one dedicated service class for emergency positioning and two service classes for different commercial services.

Step 202

This is an optional step. In some embodiments, the positioning node 100 receives positioning capabilities from the terminal 140 to be positioned. The positioning capabilities may comprise respective positioning technologies that the terminal 140 is capable of deriving the position based on. The positioning technologies may be available in different radio access network of the plurality of radio access networks 110, 120.

In some embodiments, each respective positioning capability of the terminal 140 specifies the radio access technology for that positioning capability and/or the measurement capability for that positioning capability.

This may be performed on request or in an unsolicited manner or triggered by an event, e.g. due to handover or roaming. This is related to point B5 above. The positioning capabilities may also be received at the beginning of the connection. In e.g. WCDMA it may e.g. be signalled already at call setup or it may be signalled later.

The capability of a RAN/RAT being reported may this way be augmented with the positioning capabilities that each other RAN/RAT possesses, for the specific terminal 140.

Step 203

This is also an optional step. In some embodiments the positioning node 100 retrieves prior quality of service parameters for supported positioning methods, and positioning capabilities of the plurality of RANs of different RATs. The prior quality of service parameters may be pre-configured in the positioning node 100, e.g. for a specific positioning method and specific client type or LCS service class.

Step 204

The positioning node 100 selects at least one positioning method of a plurality of positioning methods of the different plurality of RANs/RATSs for positioning the terminal. The selection of the positioning method accounts for the at least one client type and at least one quality of service parameters received in the request. . This is related to point A1 above.

In some embodiments the selection of the positioning method further accounts for the retrieved prior quality of service parameters, and/or positioning capabilities of the plurality of RANa/RATs.

In some embodiments, the selection of the positioning method further accounts for positioning capabilities received from the terminal 140.

Step 205

In a first embodiment, the positioning node 100 sends a request to the terminal 140 to perform positioning measurements according to the selected positioning method. The measurement shall be performed in the first radio access network 110. This may be pointed out implicitly that the terminal 100 shall perform the measurements in the radio access network that it is camping on, which in this case is in the first radio access network 110. Network or radio transmission node 145 positioning measurements may also be requested from the radio transmission nodes of the corresponding RAN 110.

Measurement request and measurement reporting may be performed over the control plane or over the user plane, and it may involve inter-radio access technology measurements. This is related to point B3, B13 and B16 above.

Step 206

This step is performed in a another embodiment, as an alternative to step 205. The terminal 140 is as mentioned earlier camping on the first radio access network 110, but in this embodiment, the selected positioning method indicates that inter-radio access technology measurements from the second radio access network 120 are available for retrieving position information. It may indicate that measurements performed in the second radio access network 120 should preferably be used to retrieve position related information. The second radio access network 120 is different from the radio access network where the terminal 140 is camping on. The position information is not available by inter-radio access technology measurements from the first radio access network 110.

To enable positioning measurements in a different RAN for the terminal 140 when it has no capability of parallel multi-RAT measurements, the network may trigger handover to another RAT or the network may configure measurement gaps for inter-RAT positioning measurements. When configuring handover for positioning measurements, the positioning node 100 requests handover of the terminal 140 to the second radio access network 120.

This step and also steps 207-209 may be repeated for all radio access networks that the terminal 140 has positioning capability for.

The handover from the first radio access network is network 110 to the second radio access network 120 may be from at least one of the GSM, WCDMA, LTE or CDMA 2000 radio access networks, to another of the GSM, WCDMA, LTE or CDMA 2000 radio access networks.

In some embodiments, the request is sent to a handover controlling instance of said originating and destination radio access networks, i.e. to a controlling instance of the first radio access network 110 and to a controlling instance of the second radio access network 120.

Step 207

This step may be performed in the second embodiment. The positioning node 100 sends a request to the terminal 140 to perform positioning measurements in the second radio access network 120 according to the selected positioning method.

Step 208

This step may be performed in the first embodiment and in the second embodiment. When the terminal 140 has performed the positioning measurements in the first RAN 110 or in the second RAN 120 depending on the positioning method that was selected, the positioning node 100 receives the positioning measurements from the terminal 140. This may be performed over the control plane or over the user plane. This is related to point B6 above. The positioning measurement results may be obtained from different RANs exploiting different RATs. The measurement report may comprise measurements performed on a single RAN/RAT. In this case multiple measurement reports may be transmitted by the terminal 140 and expected to be received by the positioning node 100 when multi-RAT measurements are performed or requested to be performed. In another embodiment, a measurement report comprises measurements from multiple RAN/RATs. This is related to point C above.

Step 209

This step is performed in the second embodiment when the terminal 140 has been handed over to the second radio access network 120. The positioning node 100 requests handover of the terminal 140 from the second radio access network 120 back to the first radio access network 110 when the terminal 140 has performed the measurements in the second access network 120. The handover to the second radio access network 120 may be been time-limited, i.e. after a certain time in the second RAN/RAT, the terminal 140 makes a handover back to the first RAN/RAT. The terminal 140 may request or perform handover after the positioning measurements in the second RAN/RAT have been completed.

Step 210

The positioning node 100 determines the position of the terminal 140 based on the received positioning measurements from the terminal 140 according to the selected positioning method. In some embodiments the determination may be based on received positioning measurements from a transmission radio node in at least one RAT.

In some embodiments, this step of determining is performed by combining received positioning measurements that comprise positioning measurements from the user plane and the control plane into a combined position of the terminal 140.

In some embodiments this step of determining may further be performed by combining received positioning measurements that comprise positioning measurements obtained from different radio access networks 110, 120 exploiting different RATs, into a combined position of the terminal 140.

A special example of this is that user plane positioning may be augmented by control plane position information retrieved even from another RAN/RAT.

In some embodiments the said positioning measurements have been converted to a generalized measurement report format prior sending the measurements. The generalized report format may comprises a format different from that which is used for reporting measurements for positioning involving only one of the plurality of radio access networks 110, 120, 121 of different access technologies.

Step 211

In some embodiments the positioning node 100 sends the determined terminal position at least to the requesting node 130. This is related to point B7 above.

In some embodiments the plurality of client types comprised in the request sent to the positioning node is a generalized extended set of client types where each client type, supported by at least one of the plurality of radio access networks 110, 120, 121 of RATs, has at least one corresponding client type in the generalized extended set of client types.

In some embodiments the plurality of service classes is a generalized extended set of service classes where each service class supported by at least one of the plurality of radio access networks 110, 120, 121 of different access technologies, has at least one corresponding service class in the generalized extended set of service classes.

In any positioning architecture, the following three network elements may be involved: an LCS client, an LCS target and an LCS server. The LCS target device may e.g. be a UE, a user terminal or a radio node in general, e.g. a sensor, a relay, or a small base station. The LCS is a physical or logical entity managing positioning for the LCS target device by obtaining measurements and other location information, providing assistance data to assist the LCS target device in measurements, and computing or verifying the final position estimate. Examples of LCS servers in LTE are Evolved Serving Mobile Location Center (E-SMLC) in a the control plane solution and Secure User Plane Location (SUPL) Location Platform (SLP) in a user-plane solution, both may be referred to as a positioning node herein. Further in the text, the description given for a terminal such as a UE, also applies to LCS target in general.

A LCS client is a software and/or hardware entity that interacts with a LCS server for the purpose of obtaining location information for one or more LCS targets, i.e. the entities being positioned. LCS clients may or may not reside in the LCS targets themselves. LCS clients subscribe to LCS to obtain location information, and LCS servers process and serve the received requests and send the positioning result to the LCS target. The positioning result comprises estimated location coordinates, although it may also include a velocity estimate or the location failure indication in case of a failure.

Advantages Over Prior Art Single-RAT Single-Plane Technical Solutions.

Single-RAT single-plane technical solutions have at least the following drawbacks and problems associated with them.
The statistical availability of positioning results available to the user may be less than what is possible when positioning resources and information is gathered from different RANs and RATs.
The statistical accuracy of positioning results available to the user within a single

RAT may be lower than what is possible when positioning resources and information are gathered from different RANs and RATs.
The cost of purchase, maintenance and operation for operators to maintain a positioning functionality at a specific quality in each specific RAN, may be higher than when it is possible to merge positioning resources available in different RANs and RATs, run by said operator; furthermore, the operator may have already deployed different RATs in the same area, so not exploiting the available network resources as a common pool of resources is an inefficient network operation;
The performance of user plane positioning is dependent on positioning information available in the terminal and thus may have a worse performance than what may be possible when utilizing control and user plane solutions in a complementary way.

Below follows examples of some embodiments. Other variants are of course possible as well.

Architecture Overview

An embodiment of the architecture of a disclosed multi-RAT position method selection mechanism is depicted in FIG. 3. In the embodiment in the figure positioning requests may be received at the positioning node 100 from any of the 8 types of sources, from requesting nodes 130 of different core networks corresponding to different

RANs/RATs and to corresponding user plane systems. The idea to have a subset of all requesting nodes 130 interfaced to one positioning node 100, is disclosed in embodiments herein. These interfaces are also used to return an obtained position result after the positioning has terminated. In one embodiment of the solution, the subset comprises only the entities, i.e. the requesting nodes 130, that belong to a same plane e.g., a user plane or a control plane.

The positioning node 100 has access to multiple RANs/RATs, the RANs/RATs 110, 120, 121 in the example of FIG. 3, in order to obtain a position of the terminal 140. Since most terminals handle multiple RATs today, embodiments hence disclose functionality for position method selection that is capable of selecting positioning methods/measurements from all RANs/RATs, in order to achieve the requested result. This is performed by a multi-RAT positioning method selection unit 310 in FIG. 3. In that sense the positioning method selection mechanism operates like a switch between RANs/RATs for positioning purposes.

As previously described, sometimes inter-RAT measurements are available to retrieve information from other RANs/RATs. In case other information is preferred, the positioning method selection mechanism may request handover of the terminal 140 to another RAN/RAT for positioning purposes or ensure that the required inter-RAT measurements are possible during the specified time intervals. For this purpose, a handover handler 320 is provided in the positioning node 100.

As can be seen in FIG. 3, the multi RAT positioning method selection mechanism is via a positioning method block 330 interfaced to all the RANs/RATs served by the positioning node 100. These interfaces are the standard ones described below, for retrieving positioning results in terms of positions or positioning measurements, from the different RANs/RATs.

Multi-RAT Position Method Selection

The multi RAT position method selection mechanism may make use of previously described principles used in the WCDMA solution described above. In this case, the following steps and pieces of information are included.

1. Generalized service class configuration and selection. As compared to prior art, herein it is disclosed a use of Client Types from all RANs/RATs, as well as the use of an extended number of service classes, possibly 8, 16 or 32. Each service class may comprise independent configurability and logic for items 2-4 below.

2. Configuration for, as well as generalized selection of the positioning method for the first attempt. As compared to prior art, embodiments disclose the use of
a. An extended number of alternative positioning methods for the first positioning attempt, possibly 8, 16 or 32 alternatives.
b. The use of positioning methods from different RANs/RATs.

3. Configuration for, as well as generalized selection of the positioning methods for a number of M re-attempts. As compared to prior art, embodiments disclose the use of
a. An extended number of alternative positioning methods for each re-attempted positioning, possibly 8 16 or 32 alternatives.
b. The use of positioning methods from different RANs/RATs.

4. Configuration of, as well as quality of service evaluations and subsequent actions for
a. A first positioning attempt
b. An M positioning re-attempts

As compared to prior art, embodiments disclose the use of subsequent actions depending on
a. An achieved QoS so far.
b. An prior QoS configured for the positioning methods configured for each positioning re-attempt.

It shall be noted that the positioning method selection algorithm is allowed to account for example for the remaining positioning time and the achieved accuracy so far, thereby making a better selection of the positioning method used for the re-attempt, than what is known in prior art.

In some embodiments measurement conversion to a generalized multi-RAT form/format may also be needed, e.g., shape conversion, with such a multi-RAT positioning architecture since even similar in essence measurements do not necessarily have the same properties, uncertainty, etc.

Handover Handler 320

As discussed above, embodiments herein may be seen as an intelligent switch that may exploit positioning resources in all RATs that are supported by the terminal 140. Since all position related measurements are not available as inter-RAT measurements, the solution may include the handover handler 320 that triggers handover to a different RAT/RAN while the handover back is also ensured after the positioning measurements on the RAT/RAN are completed. The handover handler 320 hence comprises means for
Accepting requests for inter-RAT handover from the multi-RAT position method selection mechanism.
Requesting/forcing handover from at least one of the GSM, WCDMA, LTE or COMA 2000 RANs, to another of the GSM, WCDMA, LTE or CDMA 2000 RANs, by signaling means connecting to the inter-RAT handover controlling instance of said originating and destination RANs.
Accepting requests for inter-RAT handover back to the originating RAN from the multi-RAT position method selection mechanism, by signaling means connecting to the inter-RAT handover controlling instance of said originating and destination RANs.
Requesting/forcing handover back to the originating RAN.

User Plane Positioning Support

An enhancement of the functionality would be to include signaling means from the multi-RAT positioning method selection mechanism, to the user plane instance of the involved terminal. This signalling may then include means for signaling of all positioning measurements that are only available in the control plane of the different RANs. Examples of this include signaling of RTT measurements obtained in WCDMA.

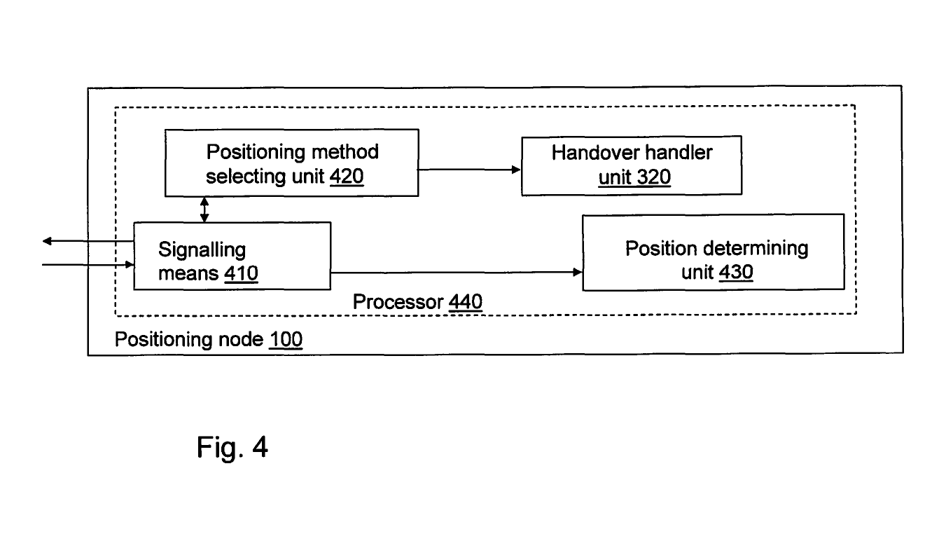

To perform the method steps above for selecting a positioning method, the positioning unit 100 comprises an arrangement depicted in FIG. 4. As mentioned above the positioning node 100 is arranged to be connected to a plurality of radio access networks 110, 120, 121 of different access technologies and to a plurality of core networks. The plurality of radio access networks 110, 120, 121 of different radio access technologies may comprise any of GSM, WCDMA, LTE or CDMA 2000 radio access networks, or may comprise any of the radio access networks: user plane CDMA 2K, user plane GSM, user plane WCDMA, user plane LTE, control plane CDMA 2K, control plane GSM, control plane WCDMA, control plane LTE.

The positioning node 100 comprises signalling means 410 such as a receiver or transceiver configured to receive from a requesting node 130, a request for a positioning of a terminal 140. The request comprises at least one of a plurality of client types, and at least one of a plurality of quality of service parameters.

In some embodiments, the signalling means 410 further is configured to receive positioning capabilities from the terminal 140 to be positioned. The positioning capabilities comprise respective positioning technologies that the terminal 140 is capable of deriving the position based on, said positioning technologies being available in different radio access network of the plurality of radio access networks 110, 120.

In some embodiments, the signalling means 410 further is configured to retrieve prior quality of service parameters for supported positioning methods, and positioning capabilities of the plurality of radio access networks 110, 120 of different access technologies. This information may be pre-configured in the positioning node 100.

In some embodiments the terminal 140 is camping on a first radio access network 110. The first radio access network 110 is comprised in the plurality of radio access networks 110, 120 comprising the respective positioning technology. In these embodiments, the signalling means 410 may further be configured to send a request to the terminal 140 to perform positioning measurements in the first radio access network 110 according to the selected positioning method. The positioning measurements to be performed according to the request may involve inter-radio access technology measurements.

The positioning node 100 further comprises a positioning method selecting unit 420, which e.g. may be the multi RAT position method selection unit 310 depicted in FIG. 3. The positioning method selecting unit 420 is configured to select at least one positioning method of a plurality of positioning methods of the different plurality of radio access networks 110, 120, 121 and or radio access technologies or user and control plane positioning methods for positioning the terminal 140. The selection of the positioning method accounts for the received at least one client type and at least one quality of service parameters of the request.

In some embodiments wherein positioning capabilities of the terminal 140 are received, the positioning method selecting unit 420, is configured to further account for terminal positioning capabilities when selecting the positioning method. In these embodiments, each respective positioning capability of the received terminal positioning capabilities may specify the radio access technology for that positioning capability and/or the measurement capability for that positioning capability.

In some embodiments wherein prior quality of service parameters for supported positioning methods, and positioning capabilities of the plurality of radio access networks 110, 120 of different access technologies are retrieved, the positioning method selecting unit 420, 310 is configured to further account for the retrieved prior quality of service parameters, and positioning capabilities of the plurality of radio access networks 110, 120 of different access technologies when selecting of the positioning method.

In some embodiments wherein the terminal 140 is camping on a first radio access network 110, position information for the sought position is not available by inter-radio access technology measurements from said first radio access network 110, but according to the selected positioning method, inter-radio access technology measurements from another second radio access network 120, other than the one the terminal 140 is camping on are available to retrieve position information from. The first radio access network 110 and the second radio network 120 are comprised in the plurality of radio access networks comprising the respective positioning technologies. In these embodiments, the positioning node 100 may further comprise the handover handler 320 configured to request handover of the terminal 140 to the second radio access network 120. Note that inter-radio access technology measurements do not require handover, it is the measurements in the other RAN that are not implemented as inter-radio access technology that require handover.

In these embodiments the signalling means 410 further is configured to send a request to the terminal 140 to perform positioning measurements in the second radio access network 120, according to the selected positioning method.

The handover handler 320 may further be configured to request handover of the terminal 140 from the second radio access network 120 back to the first radio access network 110.

The handover from the first radio access network 110 to the second radio access network 120 may be from at least one of the GSM, WCDMA, LTE or CDMA 2000 radio access networks, to another of the GSM, WCDMA, LTE or CDMA 2000 radio access networks.

In some embodiments, the signalling means 410 further is configured to receive positioning measurements from the terminal 140. In these embodiments the positioning node 100 may further comprise a position determining unit 430 configured to determine the position of the terminal 140 based on the received positioning measurements from the terminal 140 according to the selected positioning method.

The position determining unit 430 may further be configured to determine the position of the terminal 140 by combining received positioning measurements that comprises positioning measurements from the user plane and the control plane into a combined position of the terminal 140.

The position determining unit 430 may further be configured to determine the position of the terminal 140 by combining received positioning measurements that comprises positioning measurements obtained from different radio access networks 110, 120 exploiting different radio access technologies, into a combined position of the terminal 140.

LCS Position Request/Report Information and Interfaces

As mentioned above, the interfaces to be used for retrieving positioning results in terms of positions or position measurements, from the different respective RANs/RATs may be the standard interfaces as described below in terms relating to the respective standard/technology.

GSM

In GSM, the LCS related signalling service between GSM Enhanced GPRS (EDGE) Radio Access Network (GERAN) and the core network may be carried over
1. an A interface to a 2G-Mobile Switching Center (MCS) using Base Station System Application Part (BSSAP) protocol in 3GPP, or
2. an Gb interface to 2G-Serving GPRS Support Node (SGSN) using Base Station System GPRS (BSSGP) protocol in 3GPP, or
3. an Iu interface to 3G-MSC or 3G-SGSN in 3GPP.

Next, the LCS related procedures on the interfaces to GERAN will be outlined. A Iu interface procedure is described further in connection to WCDMA below.

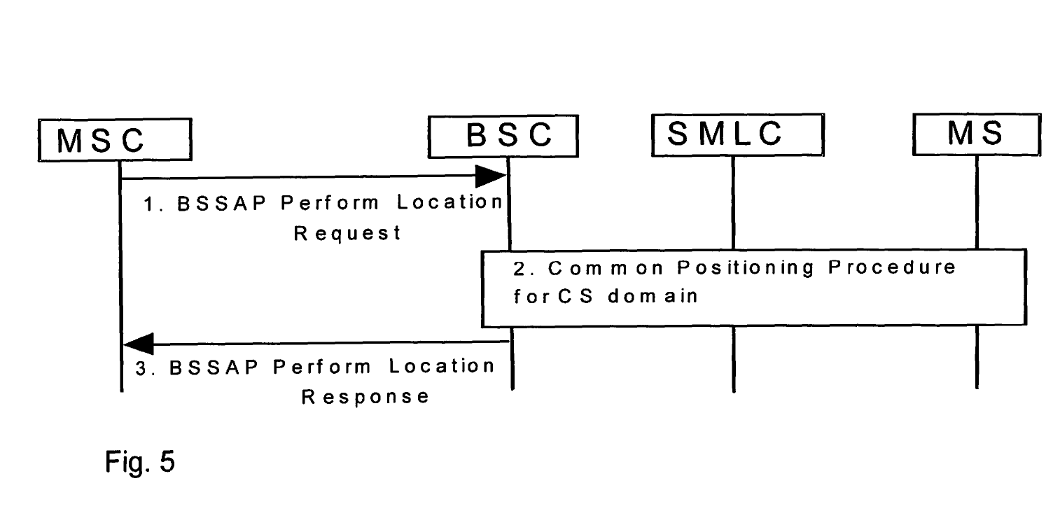

A message sequence used in the Circuit Switched (CS) domain on the A interface is shown in FIG. 5 which depicts positioning procedure over the A Interface.
1. The MSC sends a BSSAP Perform Location Request message to request a BSC to start the positioning procedure. A Location Type is always included. Depending on the type of location request, additional parameters may be included to provide a Cell Identifier, Classmark Information Type 3, LCS Client Type, Chosen Channel, LCS Priority, Quality of service, Assisted Global Navigation Satellite System (A-GNSS) Assistance Data, and Application Protocol Data Unit (APDU).
2. Common positioning procedures for CS domain are executed.
3. The BSC sends a BSSAP Perform Location Response message to the MSC. A location estimate, velocity estimate, positioning data, deciphering keys, or LCS Cause may be included.

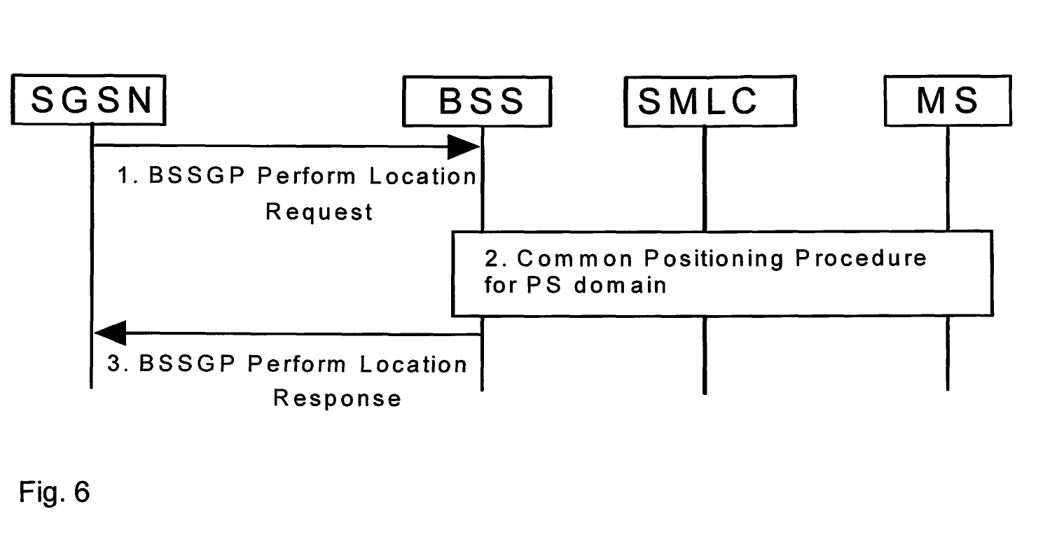

Next, a core network position procedure initiation over the Gb interface will be outlined. A message sequence used in the PS domain over the Gb interface is shown in FIG. 6.
1. A SGSN sends a BSSGP Perform Location Request message to request the base station subsystem (BSS) to start the positioning procedure.

Current Cell Identifier, and LCS Capability Information Elements (lEs) are always included. Depending on the type of location request, additional parameters may be included in a BSSGP Perform Location Request message to provide LCS Client Type, LCS Priority, LCS Quality of Service, and A-GNSS Assistance Data.
2. The common positioning procedures for Packet Switched (PS) domain are executed.
3. The BSS sends a BSSGP Perform Location Response message to the SGSN. A Temporary Logical Link Identifier (TLLI) and a BSSGP Virtual Connection Identifier (BVCI) identifying a cell from which a last Logical Link Control (LLC) protocol data unit (PDU) was received from the Mobile Station (MS) such as the terminal 140, are always included. A location estimate, velocity estimate, positioning data, deciphering keys, or LCS Cause may be included.

In both the CS and PS procedures, the LCS Client Type may take one of eight predefined values, which are identical to those used in WCDMA and listed under the WCDMA section below. A Quality of Service Parameter is also identical to the one used in WCDMA as well as the reported location estimate.

The positioning functionality in GERAN is typically implemented in a separate node, the Serving Mobile Location Centre (SMLC), but the functionality may also reside in the BSC. The interface between BSC and SMLC is specified 3GPP.

CDMA2000

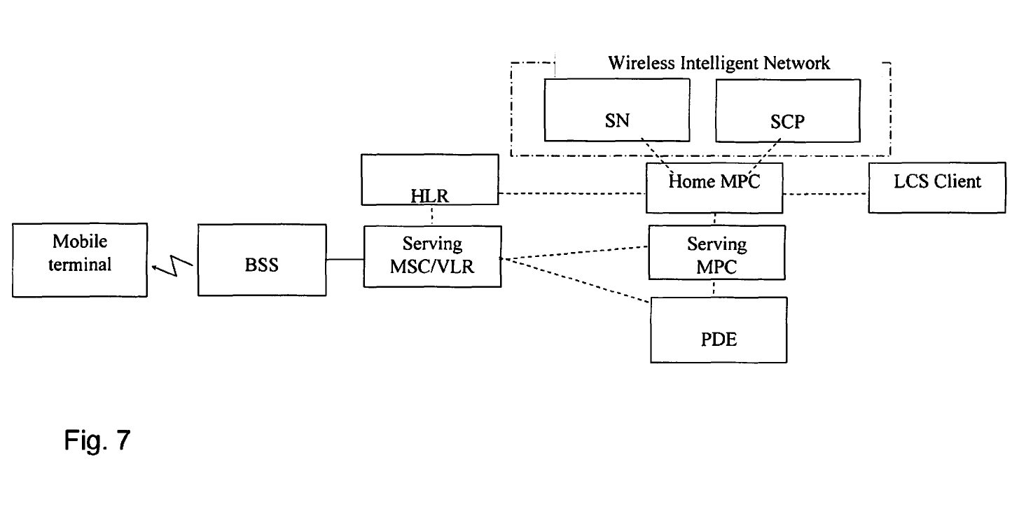

FIG. 7 illustrates the positioning architecture in CDMA2000 networks based on an IS-41 interface. The IS-41 standard is used for interconnecting Mobile Switching Centers (MSC), Visited Location Register (VLR), Home Location Register (HLR) and other service elements. HLR keeps track of terminals' last registered MSCNLR and/or MPC address as well as contains subscription information. The functionality of IS-41 is similar to that of GSM Mobile Application Part (MAP).

The location service is based on IS-41 signaling and supported by Mobile Position Center (MPC), Position Determination Center (PDE), HLR, MSCNLR, etc., and supports both IS-95 and CDMA2000 terminals. IS 95 is the standard from which COMA 2000 evolved. IS-95 is the CDMA 2G standard and is primarily intended for voice communication.

An MPC and the Position Determination Entity (PDE) are the two positioning entities in the core network. MPC manages the position information within the position network, stores if necessary, selects PDEs for position determination and forwards a position estimate to the requesting entity such as LCS client. Home MPC is the one to which the terminal is subscribed to, while Serving MPC is associated with the serving MSC. MPC and HLR together verify whether the LCS client is authorized to locate a particular terminal according to Location Information Restriction which sets authorization rules.

An LCS Client which subscribes to LCS interacts with the MPC to obtain positions for one or more terminals based on a request containing such parameters as Positioning QoS (PQoS), etc. IS-41 is often used as the interface, but it can also be other open or proprietary interfaces that are applied.

Using service request parameters, e.g. Parameterized Quality of Service (PQoS) as input, PDE determines the geographical position of a terminal applying the suitable positioning method.

A Service Node (SN) and a Service Control Point (SCP) are the entities that belong to the Wireless Intelligent Network and may additionally support (Location-Based Service) LBS.

The following Client Type categories are supported
Value Added Service LCS Clients, which use LCS to provide services to terminals,
Wireless Service Provider LCS Clients, which use LCS to support Wireless Intelligent Network services, bearer services, O&M, etc.,
Terminal-Originating Position when the terminal position is transmitted on the request of the terminal, such as terminal 140, to a specific LCS Client.

An LCS Client subscription profile, among the others, contains target terminal list, terminal barring list, maximum transaction rate, a range of applicable PQoS levels that reflect accuracy, response time, priority and maximum age of the position information. Although PQoS give the minimum requirements for a position estimate, the LCS Client may choose to specify whether a lower level is still acceptable.

The position determination in CDMA2000 networks is defined by an IS-801 standard. A position Determination Data Message is used in Request and Response operations between the terminal and the network to request/provide/exchange the information. These messages are sent either over the CDMA Traffic Channel or the CDMA Control Channel using Layer 2 Data Burst Messages in acknowledged mode.

In CDMA2000 network evolved towards all-IP architecture, AAA-based protocol will replace IS-41 for service registration and access control, which will impact the evolved positioning architecture accordingly.

WCDMA

In UMTS, the signalling service between UTRAN or GERAN (in Iu mode) and the core network (CN) is provided by the radio network layer signalling protocol called Radio Access Network Application Part (RANAP). At least the following RANAP functions are related to LCS,
Controlling location reporting—the function allows the CN to operate the mode in which the UTRAN reports a UE location using message
   LOCATION REPORTING CONTROL transmitted from CN to RNC;
Location reporting—the function used for transferring the actual location information from RNC to the CN using message
   LOCATION REPORT;
Location related data—the function allows the CN to either retrieve from the RNC deciphering keys, to be forwarded to the UE such as the terminal 140, for the broadcast assistance data, or request the RNC to deliver dedicated assistance data to the UE by means of messages:
   LOCATION RELATED DATA REQUEST,
   LOCATION RELATED DATA RESPONSE,
   LOCATION RELATED DATA FAILURE.

It is specified under “Functional Stage 2 Description of Location Services” in 3GPP TS. 23.271 that a location service request shall include, among the others, such attributes like LCS Client identity, LCS Client Type, and also, if needed, supported geographical shapes, positioning priority, service identity and/or type, and requested QoS information. In UTRAN, this functionality is enabled by RANAP, so that the LCS Client may request a certain QoS of the positioning functionality available in the RNC of UTRAN. The RNC and its corresponding NodeBs such as e.g. the radio transmission node 145 of FIG. 1, are called the Radio Network Subsystem, or RNS; there may be more than one RNS present in an UTRAN.

In WCDMA the request information that is relevant for embodiments herein may hence be received over the RANAP interface, from the CN. The serving RNC received information on the client type and on the requested QoS in the LOCATION REPORTING CONTROL message.

The Client Type information is important in practice since it allows for configuring LCS QoS discrimination in a flexible way. Also, there may exist some restrictions for certain LCS client types. For example, in the US, national interim standard TIA/EIA/IS-J-STD-036 restricts the geographic shape for an emergency services LCS client to minimally either an “ellipsoid point” or an “ellipsoid point with uncertainty circle and confidence”.

As stated above, in UTRAN, the LCS Client type is signaled in the location reporting control message as one of 8 pre-defined values in UTRAN, said values being used to discriminate between different services. The following Client Type values are supported by UTRAN Iu interface,
Emergency Services,
Value Added Services,
Public Land Mobile Network (PLMN) Operator Services,
Lawful Intercept Services,
PLMN Operator Broadcast Services,
PLMN Operator Operation and Maintenance Services,
PLMN Operator Anonymous Statistics Services,
PLMN Operator Target MS Services Support.

The requested QoS may be defined at least by the following information elements of the RANAP LOCATION REPORTING CONTROL message,
Response time, values: high/low, which is not mapped to time in the standard;
Accuracy code, encoded with 128 values, which is interpreted as the radius in meters of an uncertainty circle when decoded.
Vertical accuracy code, encoded with 128 values, which is interpreted as the size of the uncertainty interval, but it is unclear in the standard whether it is one- or two-sided.

The reporting functionality provided in WCDMA returns the computed position as information elements in the RANAP message LOCATION REPORT. 3GPP supports 7 formats, these being defined in “Universal Geographic Area Description” in 3GPP. Which format that is used depends on the positioning method that is used, and on the reporting capabilities at the receiving end. The standardized formats comprise
Polygon
Ellipsoid Arc
Ellipsoid Point
Ellipsoid Point with Uncertainty Circle
Ellipsoid Point with Uncertainty Ellipse
Ellipsoid Point with Altitude
Ellipsoid Point with Altitude and Uncertainty Ellipsoid

Positioning functionality for WCDMA may be further divided into a so called SAS-centric and an RNC centric architecture. Here SAS is an abbreviation for Stand-Alone SMLC, the broken out positioning node. The SAS-centric architecture is the one that is relevant for some embodiments of the present solution since in that architecture the positioning functionality of the RNC is broken out to the so called SAS node. This node is typically very similar to the positioning nodes of GSM, i.e. the Serving Mobile Positioning Center (SMPC) and LTE, i.e. the Evolved SMLC, (E-SMLC). For positioning the SAS node takes the master role and the RNC is slaved, acting as a relay for measurement requests and reports and as a position measurement node. The required signaling between the SAS node and the RNC is carried out over the PSAP interface, which is dedicated to carry position information only.

LTE

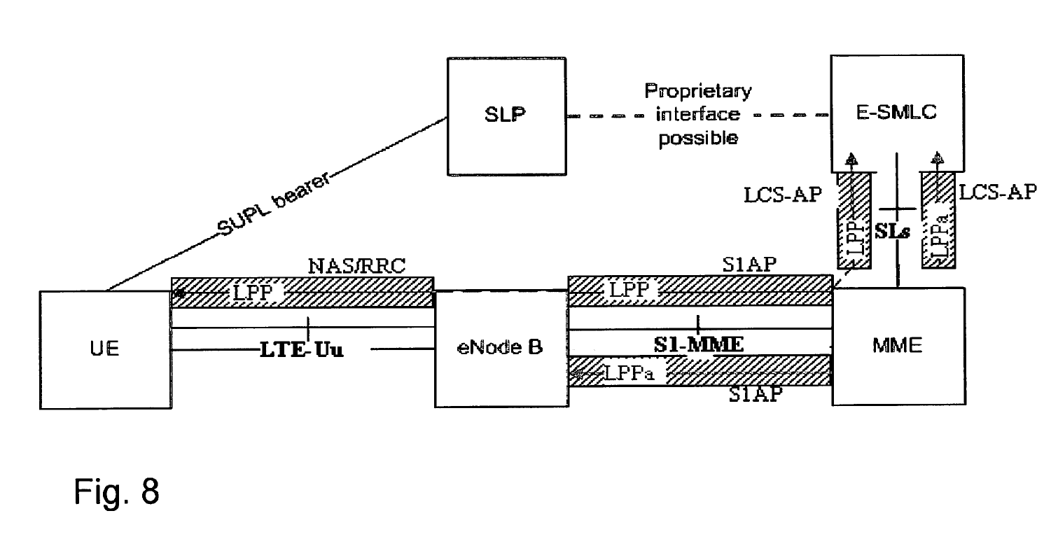

In LTE, the basic Evolved Packet System (EPS) architecture comprises two nodes in the user plane, a base station and an Evolved Packet Core (EPC) network Gateway (GW). The node that performs control-plane functionality, the Mobility Management Entity (MME) is separated from the node that performs bearer-plane functionality, i.e. GW. Signaling service between E-UTRAN and EPC is provided over the S1 interface by means of S1 Application Protocol (S1AP). An S1 interface between eNodeB such as the radio transmission node 145, and MME is called S1-MME and is utilized in control-plane positioning solution, see FIG. 8. FIG. 8 depicts positioning architecture and protocols in E-UTRAN, control plane. LTE Positioning Protocol Annex (LPPa), see FIG. 8, is a protocol between eNodeB and E-SLMC which conducts the LPPa Location Information Transfer procedures for positioning-related information and LPPa Management procedures not specifically related to LCS. SLs interface is standardized between MME and E-SLMC with LCS-Application Protocol operating over the interface. The S1 interface between eNodeB and Serving GW is called S1-U and it is utilized in user-plane positioning solutions (not shown in FIG. 8).

The following location-related procedures are defined for S1AP:
Location Reporting Control, which allows the MME to request the eNodeB, such as the radio transmission node 145, to report the current location of a UE, such as the terminal 140, with message
   LOCATION REPORTING CONTROL;
Location Report, by which the eNodeB provides the UE's current location to the MME by using message
   LOCATION REPORT;
Location Report Failure Indication, by which eNodeB informs MME that a Location Reporting Control procedure has failed, with message
   LOCATION REPORT FAILURE INDICATION.

LOCATION REPORTING CONTROL message only indicates how the eNodeB shall report to MME and what type of the location information, e.g., CSG or TAI. S1AP messages as such do not contain information on the required accuracy, response time, etc. This information is carried by means of LTE Positioning Protocol (LPP), while using S1AP protocol as a transport over the S1-MME interface, so that LPP messages are carried as transparent PDUs over S1-MME.

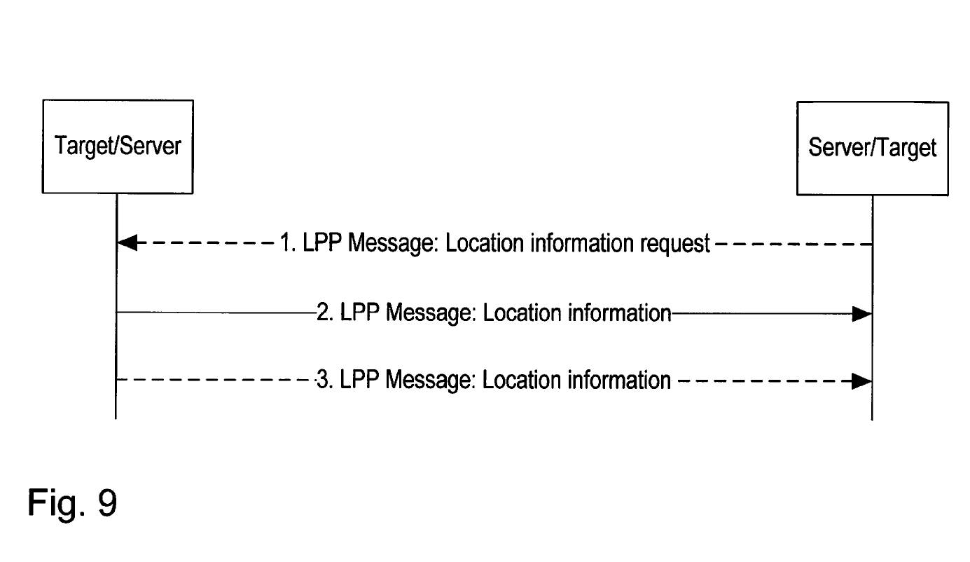

LPP is a point-to-point protocol used between a location server and a target device in order to position the target device using position-related measurements obtained by one or more reference sources. For LPP messages, a server may, for example, be E-SLMC in the control plane or SLP in the user-plane, while a target could be a UE or SET in the control and user planes, respectively. LPP uses RRC as a transport over Uu interface between UE and E-SLMC, S1AP over S1 and SLs interface between eNodeB and E-SLMC. The following transactions have been specified for LPP,
capability transfer procedure for requesting and providing messages,
assistance data transfer procedure for requesting and providing messages,
location information transfer for requesting and providing messages see FIG. 9. FIG. 9 depicts LPP Location Information Transfer procedure between UE and E-SLMC.

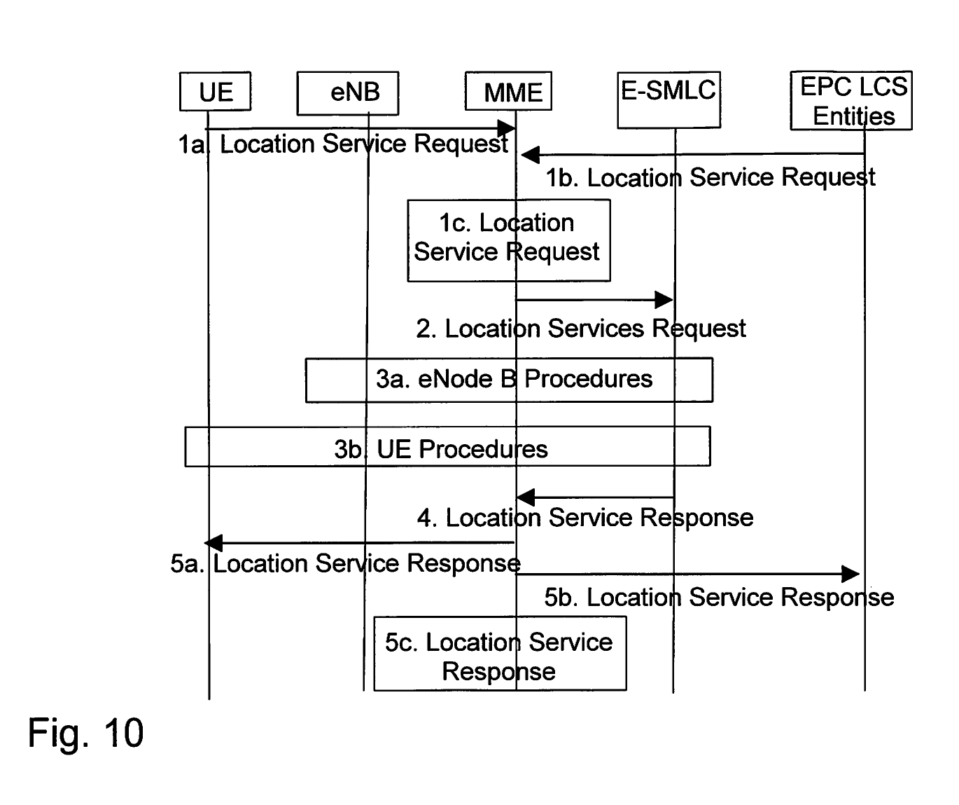

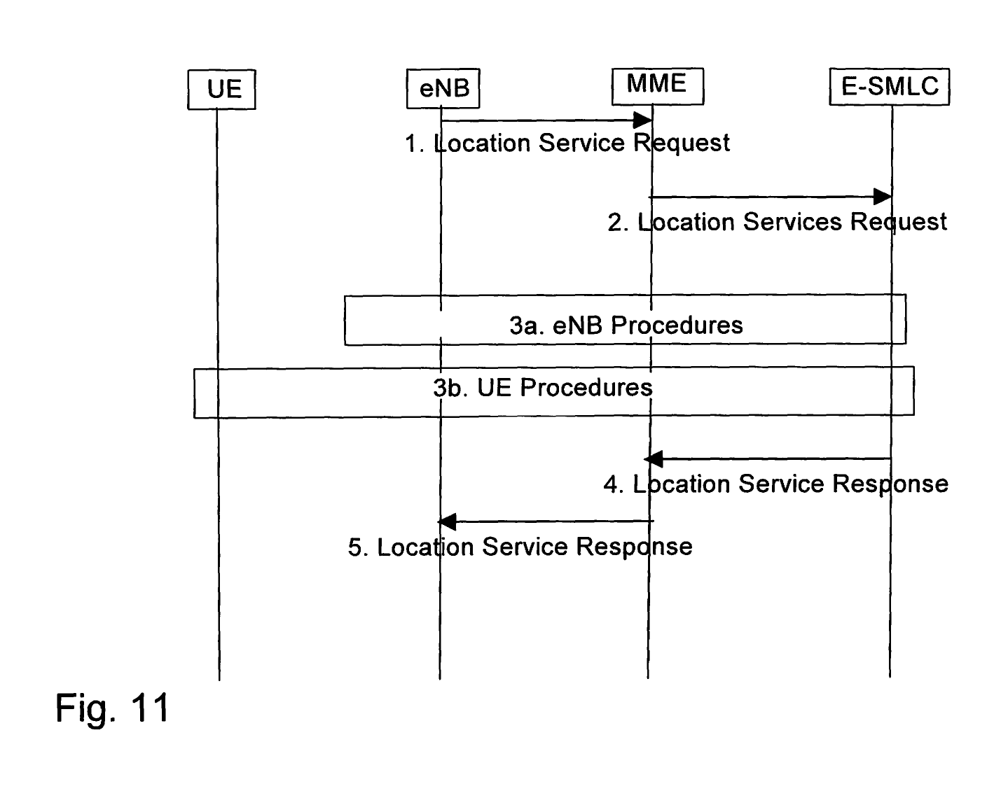

FIG. 10 depicts Location Service Support by E-UTRAN for positioning a target UE when the service is requested by UE, MME or other EPC LCS entities steps 1a-5c, and FIG. 11 depicts Location Service Support by E-UTRAN for positioning a target UE when the service is requested by eNodeB, steps 1-5.

Depending on the source of the location service request, the procedures flow may differ. For positioning a target UE, FIG. 10 shows procedures when LCS request is triggered by UE itself, MME or some other EPC LCS entity, while FIG. 11 shows the procedures when the LCS service request is initiated by eNodeB. In all cases, a location session is invoked by the MME in order to obtain the location of the UE or perform some other location related service such as transferring assistance data to the UE. In LTE the request information that is relevant for some embodiments of the present solution may hence be received in the E-SLMC over SLs interface. LPP and LPPa transport are then supported as a part of an LCS session.

In a user-plane solution, e.g. SUPL-based, including the use of LPP over SUPL, may take place as part of the general user-plane protocol stack. SUPL occupies the application layer in the stack, with LPP, or another positioning protocol, transported as another layer above SUPL.

After the LCS session has been established, according to the current standard, the information related to LCS QoS is retrieved during the LPP capability exchange and LPP location information transfer procedures, i.e. after the LCS session has been established.

In the LPP context, capabilities refer to the ability of a target or server to support different position methods defined for LPP, different aspects of a particular position method, e.g. different types of assistance data for A-GNSS and common features not specific to only one positioning method, e.g. ability to handle multiple LPP transactions. Capability information, among the others includes methods, velocity types, geographical location types, etc.

The Client Type information in LTE is presently the same as in WCDMA. In LTE also other information may be useful for positioning method selection. The relevant information being part of the Location information request, is transmitted optionally. The relevant information for some embodiments may comprise:
Location type, e.g. a sequence of boolean indicators for defining location estimates that may be returned by the target with the estimates being one or more of the following location types: ellipsoidPoint, ellipsoidPointWithUncertaintyCircle, ellipsoidPointWithUncertaintyEllipse, polygon, ellipsoidPointWithAltitude, ellipsoidPointWithAltitudeAndUncertaintyEllipsoid or ellipsoidArc);

- Velocity type, e.g. horizontal velocity, horizontal velocity with and without uncertainty, horizontal & vertical velocity with and without uncertainty.

Note that location information transfer is a bidirectional procedure, i.e. it may be initiated by request from either side, requesting either for measurements or for estimates, when allowed, e.g., some measurement transmissions are only relevant from a target to a server.

The QoS information part of the location information request comprises the following information,
horizontal accuracy, e.g. 128 accuracy codes, 100 confidence codes,
vertical coordinate request, e.g. boolean,
vertical accuracy, e.g. 128 accuracy codes, 100 confidence codes,
response time, e.g. a value in range [1,128] seconds—the maximum response time as measured between receipt of the Request Location Information and transmission of a Provide Location Information,
velocity, e.g. boolean.

LCS Position Measurements and Interfaces

The interfaces to be used for retrieving positioning results in terms of position measurements, from the different respective RANs/RATs may be the standard interfaces as described below.

GSM

In GSM, at least the following position related information may be of interest
A cell IDs. Also available for user plane positioning and by inter-RAT measurements.
A geographical extension of the detected cells, in particular for the serving cell. Configured in positioning node.
A timing advance (TA) value. Available for user plane positioning, but not by inter-RAT measurements. The latter require handover.
The signal strengths with respect to the detected neighbor cells. Available for user plane positioning and by inter-RAT measurements.
A time difference of arrival E-OTD measurements. The E-OTD positioning method is however not in use today.
A-GPS positions.
A-GPS pseudo range measurements.

Note: In the near future more satellite navigation systems than GPS will become available. 3GPP has defined joint satellite positioning functionality denoted A-GNSS, to be used when that occurs. It is stressed that embodiments herein are to be valid also for this case, i.e. not restricted to A-GPS.

The cell ID in GSM is denoted cell global identity (CGI). The geographical extension of cells related to the CGIs are configured information, based on measurements or some coverage prediction tool. The cell description in GSM is typically configured as a circle sector, defined by a center point (usually the base station (BS) location), the antenna direction, the antenna opening angle, and the cell radius.

The timing advance (TA) value is a quantity that is used for time alignment of the GSM slots, to compensate for the distance between the base station (BS) such as the radio transmission node 145, and the terminal 140. It is a common understanding in the industry that TA is capable of determining the distance between the terminal and the BS with an accuracy of roughly 1 km, and that the different TA range intervals overlap significantly. The range corresponding to the range is often combined with the geographical extension of the cell.

The signal strengths of neighbour cell transmission are monitored continuously, e.g. in support of handover functionality. This information is particularly useful since inter-RAT measurements are defined between the cellular standards in order to support inter-RAT handover. In GSM the signal strengths are obtained over the RRLP protocol as a part of the measured cell list (MCL) in a measurement report message.

In case the system runs so-called UE based positioning, e.g. involving at least one of A-GPS and time difference of arrival measurements, both the measurement collection and the position calculation is performed in the terminal. The calculated position is then reported back to the positioning node using the Radio Resource LCS (Location) Protocol. (RRLP) protocol, as one of the 5 ellipsoid point formats. Normally one of the ellipsoid point with uncertainty ellipse 2D or the ellipsoid point with altitude and uncertainty ellipsoid 3D formats is used.

In case the system runs so-called UE assisted positioning, e.g. involving at least one of A-GPS and time difference of arrival measurements, only the measurement collection is performed in the terminal. In that case the measured pseudo ranges, for each detected satellite, are reported back to the positioning node, which then performs the position calculation step.

CDMA2000

In CDMA2000, at least the following position related information may be of interest.
The cell IDs
Receive-to-transmit time delay measured by UE
Time difference of arrival measurements for Advanced forward Link Trilateration (AFLT) positioning, a handset-based geolocation technology that has been standardized for the emergency location of CDMA terminals by the Telecommunications Industry Association's TR45.5 in IS-801.
Bearing measurements
Pilot strength and pilot phase for the reference pilot and measured neighbours
Total received power
GPS coarse position
A-GPS positions
A-GPS (pseudo range) measurements

Receive-to-transmit time delay is measured and reported by the UE, such as the terminal 140,

Time differences are measured by the terminal between CDMA pilot signals , where the term CDMA pilot signals specifically refers to the serving cell pilot signal and neighbouring cell pilot signals. At least two neighbouring cells, in addition to the reference cell, typically serving cell, along with the reference serving base station coordinates are minimally sufficient to determine the location of the mobile device, but in practice more measurements are necessary.

Bearing measurements include the azimuth and elevation angle information as well as roll angle.

GPS coarse location is reported by UE with 4.5/219 degree resolution for latitude and longitude and 5 m resolution for altitude.

The positioning-specific measurements are transmitted over the corresponding interfaces using IS-801 messaging. Inter-frequency and inter-band measurements are available. Inter-RAT measurements are also available for cell IDs, signal strength and total received power measurements since needed for mobility. Mobility signal measurements, however, are typically conducted on a smaller subset of cells than for positioning (valid for all systems described herein).

WCDMA

In WCDMA, at least the following position related information is of interest
The cell IDs. Also available for user plane positioning and by inter-RAT measurements.
The geographical extension of the detected cells, in particular for the serving cell. Configured in the positioning node.
The measured round trip time (RTT) and the latency in the UE (UE RxTx) such as the terminal 140. Not available for user plane positioning and not available by inter-RAT measurements. The latter requires handover, for the serving cell and for cells in soft handover (multi-leg RTT).
The path losses/signal strengths with respect to the detected neighbor cells.

Available for user plane positioning and by inter-RAT measurements.
Time difference of arrival measurements, namely the so called System Frame Number (SFN)-SFN type 2 measurement. The corresponding Observed Time Difference of Arrival—Idle. Period Downlink (OTDOA-IPDL) positioning method, which is supposed to use these measurements, is however not in use today in real networks.
A-GPS positions
A-GPS (pseudo range) measurements
Galileo and Additional Navigation Satellite Systems (GANSS) Timing of Cell Frames for UE positioning.

The cell ID is the most basic position information in WCDMA. The geographical extension related to the cell IDs are configured information in the serving radio network controller (RNC) node, based on measurements or some coverage prediction tool. The cell description in WCDMA is typically configured as a polygon with 3-15 corners, cf.

The RTT and Ue Rx Tx type 1 or type 2, together define the distance between the radio base station (RBS) such as the radio transmission node 145 and the terminal 110. Field trials show that these measurements are capable of determining the distance between the terminal and the RBS with an accuracy of roughly 100 m. The range is most often combined with the geographical extension of the cell, to produce a so called ellipsoid arc, this being a standardized reporting format in the WCDMA system. The RTT measurement is performed by the RBS and it is signaled back to the serving RNC over the lub interface. The UE RxTx measurement is a UE measurement which is signaled back to the serving RNC over the RRC interface. Measurement of multiple RTT/UERxTx measurements are also possible with base stations in soft handover. That enables the use of multi-leg RTT positioning.

The path losses and/or signal strengths of neighbour cell transmission are monitored continuously, e.g. in support of soft handover functionality. This information is particularly useful for some embodiments since inter-RAT measurements are defined between the cellular standards in order to support inter-RAT handover. In WCDMA the path losses and/or signal strengths are obtained over the RRC interface, as a part of a measurement report message.

In case the system runs so called UE based positioning, e.g. involving at least one of A-GPS and time difference of arrival measurements, both the measurement collection and the position calculation is performed in the terminal. The calculated position is then reported back to the positioning node over the RRC interface, as one of the 5 ellipsoid point formats. Normally one of the ellipsoid point with uncertainty ellipse 2D or the ellipsoid point with altitude and uncertainty ellipsoid 3D formats is used.

In case the system runs so called UE assisted positioning, e.g. involving at least one of A-GPS and time difference of arrival measurements, only the measurement collection is performed in the terminal. In that case the measured pseudo ranges, for each detected satellite, are reported back to the positioning node, which then performs the position calculation step. Again reporting is performed over the RRC interface.

LTE

In LTE, at least the following position related information is of interest
The cell IDs. Also available for user plane positioning and by inter-RAT measurements.
The geographical extension of the detected cells, in particular for the serving cell. Configured in the positioning node.
The timing advance (TA) value. Available for user plane positioning but not available by inter-RAT measurements. The latter requires handover.
UE such as the terminal 140, Rx-Tx and eNodeB such as the radio transmission node 145 Rx-Tx time differences, both available for user plane positioning but not available by inter-RAT measurements, which requires handover.
Angle of arrival (AoA) defined for E-UTRAN. Available for user plane positioning, but not for inter-RAT measurements.
The signal strengths and signal quality measurements with respect to the detected neighbor cells. Also available for user plane positioning and by inter-RAT measurements.
The reference signal time difference (RSTD) measurements used for Observed Time Difference of Arrival (OTDOA) positioning. To position a terminal with OTDOA, at least two for 2D position neighbors need to be measured with respect to a reference cell. Available for user plane positioning and inter-frequency measurements, but not available by inter-RAT measurements, mainly because the assistance data for inter-RAT measurements is not available, otherwise, handover would not be required, although measurement gap configuration may be needed.
A-GNSS positions
A-GNSS measurements are given by UE A-GNSS timing and code measurements and E-UTRAN GNSS timing measurements described in more detail below
   UE GNSS Timing of Cell Frames for UE positioning (T_{UE-GNSS}) is defined with respect to a cell in the LTE cellular system for a given GNSS e.g., GPS/Galileo/Glonass system. This is the timing between cell j and a GNSS-specific reference time e.g., the system time for the given GNSS. More specifically, T_{UE-GNSS} is defined as the time of occurrence of a specified E-UTRAN event according to GNSS time for a given GNSS ID. The specified E-UTRAN event is the beginning of a particular frame identified through its SFN in the first detected path in time of the cell-specific reference signals of the cell j, where cell j is a cell chosen by the UE.
   UE GNSS code measurement may be used for UE-assisted GNSS positioning. This is the GNSS code phase integer and fractional parts of the spreading code of the i^{th} GNSS satellite signal.
   E-UTRAN GNSS Timing of Cell Frames for UE positioning (T_{E-UTRAN-GNSS}) is defined as the time of the occurrence of a specified LTE event according to a GNSS-specific reference time for a given GNSS e.g., GPS/Galileo/Glonass system time. The specified LTE event is the beginning of the transmission of a particular frame identified through its SFN in the cell.

The cell ID is the most basic position information in LTE. The geographical extension related to the cell IDs are configured information in the E-SLMC node, based on measurements or some coverage prediction tool. The cell description is typically configured as a polygon with 3-15 corners.

The timing advance (TA) is a quantity that is used for time alignment, somewhat similar to GSM. The TA depends on the distance between the eNodeB and the terminal. It is a common understanding in the industry that TA is capable of determining the distance between the terminal and the eNodeB with an accuracy of roughly 100 m. The range is most often combined with the geographical extension of the cell.

The pathlosses and/or signal strengths of neighbour cell transmission are monitored continuously, e.g. in support of soft handover functionality. Applicable for both RRC_IDLE and RRC_CONNECTED states, intra- and inter-frequency. The signal quality measurements are also continuously monitored, but only applicable when in RRC_CONNECTED state, intra- and inter-frequency. The signal strength and signal quality information is particularly useful for some embodiments since inter-RAT measurements are defined between the cellular standards in order to support inter-RAT handover. In LTE the path losses and/or signal strengths and/or signal quality, when intended for mobility, are obtained over the RRC interface, as a part of a measurement report message. For positioning, these measurements may be obtained by LPP or LPPa protocols as a part of an E-CID measurement results message.

Reference Signal Time Difference (RSTD) measurements, defined as the time difference of arrival between the measured and reference cells, have been specifically introduced to support OTDOA, a positioning method based on timing difference measurements for downlink reference signals. RSTD measurements are delivered from terminal to the positioning node via LPP protocol in a measurement report message. Inter-frequency RSTD measurements may be conducted during inter-frequency measurement gaps. Although the RSTD measurements are similar to SFN-to-SFN Type 2 difference measurements standardized for UTRAN, they have not been defined for inter-RAT measurements so far.

In case the system runs so called UE based positioning, e.g. involving at least one of A-GPS and time difference of arrival measurements, both the measurement collection and the position calculation is performed in the terminal. The calculated position is then reported back to the positioning node by the LPP protocol, as one of the 5 ellipsoid point formats. Normally one of the ellipsoid point with uncertainty ellipse 2D or the ellipsoid point with altitude and uncertainty ellipsoid 3D formats is used.

In case the system runs so called UE assisted positioning, e.g. involving at least one of A-GPS and time difference of arrival measurements, only the measurement collection is performed in the terminal. In that case the measured pseudo ranges, for each detected satellite, are reported back to the positioning node, which then performs the position calculation step. Again reporting is performed over the LPP protocol.

LCS QoS Evaluation

Irrespective of the cellular system, QoS evaluation may be operated by
Checking if the response time is below the requested response time,
Calculation of areas of the geographical formats that results from each positioning method, and comparison to the area of a circle with a radius given by the requested horizontal accuracy code,
Calculation/lookup of the size of the vertical inaccuracy that results from each positioning method, and comparison to the requested vertical scalar accuracy, as given by the vertical accuracy code received e.g. over the RANAP, i.e. in UTRAN, interface.

The QoS information that is available and used in different RATs may vary, please refer to the above description.

Control Plane and User Plane Positioning

The above discussion has been focused on so called control plane positioning. However, in parallel, user plane positioning has been developed. That technology uses a data link between the terminal 140 and the positioning node 130 that is transparent to the nodes that manage the data link transmission between the terminal and the positioning node. The user plane positioning essentially emulates the control plane signalling between the positioning node and the terminal, thereby removing the need for positioning functionality in the RANs.

There is, however, a significant restriction in place for user plane positioning, in that in practice the positioning node 100 may only exploit positioning-related information that is available in the terminal 140, i.e. typically it is not possible to use positioning-related information that is only available in the RAN e.g. base stations such as PRS muting configuration. Examples of the latter type of information include e.g. time measurements like RTT in WCDMA. In LTE, the user-plane positioning server (SLP) can freely communicate via SPC with E-SLMC, which means that assistance data that were delivered to the E-SMLC via LPPa may be transferred over to the SLP for delivery to the UE via LPP over SUPL. However, there are still restrictions on the information that may be delivered by LPPa and in principle using LPPa together with user-plane positioning is possible but not always a preferable solution. Actually, embodiments herein relax these constraints since user plane positioning in one RAN/RAT, may be augmented by control plane measurements performed in another RAN/RAT.

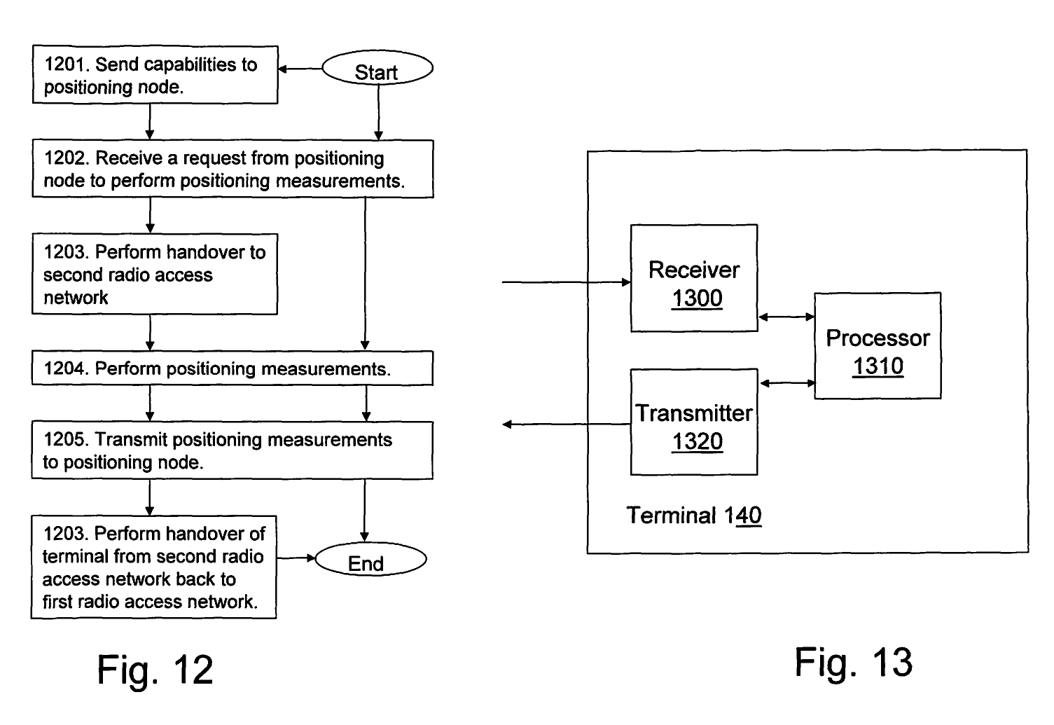

The present solution relating to a method in the terminal 140 for handling positioning of the terminal 140 according to some embodiments will now be described with reference to the flowchart depicted in FIG. 12. The terminal 140 is configured to access the plurality of radio access networks 110, 120, 121 of different access technologies for performing positioning measurements. As mentioned above, the terminal 140 is camping on the first radio access network 110. The first radio access network 110 is comprised in the plurality of radio access networks 110, 120, 121 comprising the respective positioning technologies. The method comprises the following steps, which steps may as well be carried out in another suitable order than described below.

Step 1201

This is an optional step. In some embodiments the terminal 140 sends capabilities to the positioning node 100. The capabilities may comprises capabilities related to the respective positioning technologies that the terminal 140 is capable of performing measurements for. The positioning technologies may be available in different radio access network of the plurality of radio access networks 110, 120.

Step 1202

The terminal 140 receives a request from a positioning node 100 to perform positioning measurements according to a positioning method, while involving inter-radio access technology measurements.

Step 1203

This is an optional step. In some embodiments the terminal 140 performs a handover of the terminal 140 to the second radio access network 120, for performing said measurements. In some embodiments this is performed upon receiving a request from the positioning node 100.

Step 1204

The terminal 140 performs positioning measurements at least in the second radio network 120.

In some embodiments the measurements in the second radio network 120 comprise measurements in at least one of the GSM, WCDMA, LTE or CDMA 2000 radio access networks.

Step 1205

The terminal 140 transmits to the positioning node 100, the positioning measurements comprising at least the measurements performed in the second radio network 120. This enables the positioning node 100 to determine the position of the terminal 140.

Step 1206

This is an optional step. In some embodiments the terminal 140 performs handover of the terminal 140 from the second radio access network 120 back to the first radio access network 110 after said positioning measurements have been performed.

To perform the method steps above for handling positioning of the terminal 140, selecting a positioning method, the positioning unit 100 comprises an arrangement depicted in FIG. 13. As mentioned above the terminal 100 is configured to access a plurality of radio access networks 110, 120, 121 of different access technologies for performing positioning measurements. The terminal 140 is camping on a first radio access network 110. The first radio access network 110 is comprised in the plurality of radio access networks 110, 120, 121 comprising the respective positioning technologies.

The terminal 140 comprises a receiver 1300 configured to receive a request from a positioning node 100 to perform positioning measurements according to a positioning method, while involving inter-radio access technology measurements.

The terminal 140 further comprises a processor 1310 configured to perform positioning measurements at least in the second radio network 120.

The terminal 140 further comprises a transmitter 1320 configured to transmit to the positioning node 100, the positioning measurements comprising at least the measurements performed in the second radio network 120. This enables the positioning node 100 to determine the position of the terminal 140.

The present mechanism for selecting positioning method may be implemented through one or more processors, such as a processor 440 in the positioning node 100, and the processor 1310 in the terminal 140 together with computer program code for performing the functions of the present solution. The program code mentioned above may also be provided as a computer program product, for instance in the form of a data carrier carrying computer program code for performing the present solution when being loaded into the positioning node 100 or into the terminal 140. One such carrier may be in the form of a CD ROM disc. It is however feasible with other data carriers such as a memory stick. The computer program code may furthermore be provided as pure program code on a server and downloaded to the positioning node 100, or the terminal 140.

Modifications and other embodiments of the disclosed exemplary embodiments of the invention will come to mind to one skilled in the art having the benefit of the teachings presented in the foregoing descriptions and the associated drawings. Therefore, it is to be understood that the solution(s) described is/are not to be limited to the specific embodiments disclosed and that modifications and other embodiments are intended to be included within the scope of this disclosure. Although specific terms may be employed herein, they are used in a generic and descriptive sense only and not for purposes of limitation.

Abbreviations
A-GNSS Assisted Global Navigation Satellite System
CN Core Network
E-UTRAN Evolved UTRAN
EPC Evolved Packet Core
EPS Evolved Packet System
E-SLMC Evolved Serving Mobile Location Centre
IE Information Element
LBS Location-Based Service
LCS LoCation Service
LCS-AP LCS Application Protocol
LPP LTE Positioning Protocol
LPPa LTE Positioning Protocol Annex
LTE Long-Term Evolution
MME Mobility Management Entity
NAS Non-Access Stratum
OTDOA Observed Time Difference of Arrival
PDU Packet Data Unit
QoS Quality of Service
RANAP Radio Access Network Application Part
RNC Radio Network Controller
RNS Radio Network Subsystem
RRC Radio Resource Control
S1AP S1 Application Protocol
SET SUPL Enabled Terminal
SLP SUPL Location Platform
SUPL Secure User Plane Location
TAI Tracking Area Identity
UE User Equipment
UMTS Universal Mobile Telecommunications System
UTRA UMTS Terrestrial Radio Access
UTRAN UMTS Terrestrial Radio Access Network

1. A method in a positioning node (100) for selecting a positioning method, wherein the positioning node (100) is connected to a plurality of radio access networks (110, 120, 121) of different access technologies and to a plurality of core networks, the method comprising:
receiving (201) from a requesting node (130), a request for a positioning of a terminal (140), the request comprising at least one of a plurality of client types, and at least one of a plurality of quality of service parameters,
selecting (204) a positioning method of a plurality of positioning methods of the different plurality of radio access networks (110, 120, 121) and/or radio access technologies for positioning the terminal (140), wherein the selection of the positioning method accounts for the at least one client type and the at least one of the plurality of quality of service parameters received in the request.

2. Method according to claim 1, further comprising:
receiving (202) positioning capabilities from the terminal (140) to be positioned, which positioning capabilities comprise respective positioning technologies that the terminal (140) is capable of deriving the position based on,
said positioning technologies being available in different radio access network of the plurality of radio access networks (110, 120)
and wherein the selection of the positioning method further accounts for the received terminal positioning capabilities.

3. Method according to claim 2, wherein each positioning capability of the received terminal positioning capabilities specifies the radio access technology for that positioning capability and/or the measurement capability for that positioning capability.

4. Method according to any of the claims 1-3, further comprising:
retrieving (203) prior quality of service parameters for supported positioning methods, and positioning capabilities of the plurality of radio access networks (110, 120) of different access technologies,
and wherein the selection of the positioning method further accounts for the retrieved prior quality of service parameters, and positioning capabilities of the plurality of radio access networks (110, 120) of different access technologies.

5. Method according to any of the claims 1-4, wherein the terminal (140) is camping on a first radio access network (110), which first radio access network (110) is comprised in the plurality of radio access networks (110, 120) comprising the respective positioning technologies, which method further comprises:
sending (205) a request to the terminal (140) to perform positioning measurements in the first radio access network (110) according to the selected positioning method.

6. Method according to claim 5, wherein the positioning measurements to be performed according to the request involve inter-radio access technology measurements.

7. Method according to any of the claims 1-4, wherein the terminal (140) is camping on a first radio access network (110), wherein according to the selected positioning method, measurements from another second radio access network (120) than the one the terminal (140) is camping on are available to retrieve position information, which first radio access network (110) and second radio network (120) are comprised in the plurality of radio access networks comprising the respective positioning technologies; and
sending (207) a request to the terminal (140) to perform positioning measurements in the second radio access network (120), according to the selected positioning method.

8. Method according to claim 7, further comprising:
requesting (206) handover of the terminal (140) to the second radio access network (120), for performing said positioning measurements in the second radio access network (120).

9. Method according to claim 8, further comprising:
requesting (209) handover of the terminal (140) from the second radio access network (120) back to the first radio access network (110).

10. Method according to any of the claims 8-9, wherein the handover from the first radio access network (110) to the second radio access network (120) is from at least one of a GSM, WCDMA, LTE or CDMA 2000 radio access networks, to another of a GSM, WCDMA, LTE or CDMA 2000 radio access networks.

11. Method according to any of the claims 1-10, the method further comprising:
receiving (208) positioning measurements from the terminal (140), and
determining (210) the position of the terminal (140) based on the received positioning measurements from the terminal (140) according to the selected positioning method.

12. Method according to claim 11, further comprising sending the positioning measurements, wherein said positioning measurements have been converted to a generalized measurement report format prior to sending the measurements, and wherein the generalized report format comprises a format different from that which is used for reporting measurements for positioning involving only one of the plurality of radio access networks (110, 120, 121) of different access technologies.

13. Method according to any of the claims 11-12, wherein said determining (210) comprises combining received positioning measurements that comprises positioning measurements from a user plane and a control plane into a combined position of the terminal 140.

14. Method according to any of the claims 11-13, wherein said determining (210) comprises combining received positioning measurements that comprises positioning measurements obtained from different radio access networks (110, 120) exploiting different radio access technologies, into a combined position of the terminal (140).

15. Method according to any of the claims 1-15, wherein the plurality of client types is a generalized extended set of client types where each client type, supported by at least one of the plurality of radio access networks (110, 120, 121) of different access technologies, has at least one corresponding client type in the generalized extended set of client types.

16. Method according to any of the claims 1-15, wherein a plurality of service classes is a generalized extended set of service classes where each service class supported by at least one of the plurality of radio access networks (110, 120, 121) of different access technologies, has at least one corresponding service class in the generalized extended set of service classes.

17. A positioning node (100) for selecting a positioning method, wherein the positioning node (100) is arranged to be connected to a plurality of radio access networks (110, 120, 121) of different access technologies and to a plurality of core networks, the positioning node (100) comprising:
signalling means (410) configured to receive from a requesting node (130), a request for a positioning of a terminal (140), the request comprising at least one of a plurality of client types, and at least one of a plurality of quality of service parameters,
a positioning method selecting unit (420, 310) configured to select a positioning method of a plurality of positioning methods of the different plurality of radio access networks (110, 120, 121) and/or radio access technologies for positioning the terminal (140), wherein the selection of the positioning method accounts for the at least one client type and the at least one of the quality of service parameters received in the request.

18. A positioning node (100) according to claim 17, wherein the signalling means (410) is further configured to receive positioning capabilities from the terminal (140) to be positioned, which positioning capabilities comprise respective positioning technologies that the terminal (140) is capable of deriving the position based on, said positioning technologies being available in different radio access network of the plurality of radio access networks (110, 120)
and wherein the positioning method selecting unit (420, 310) is configured to further account for the received terminal positioning capabilities when selecting of the positioning method.

19. A positioning node (100) according to any of the claims 17-18, wherein the terminal (140) is camping on a first radio access network (110), wherein according to the selected positioning method, measurements from another second radio access network (120) than the one the terminal (140) is camping on are available to retrieve position information, which first radio access network (110) and second radio network (120) are comprised in the plurality of radio access networks comprising the respective positioning technologies, and wherein the signalling means (410) further is configured to send a request to the terminal (140) to perform positioning measurements in the second radio access network (120), according to the selected positioning method.

20. A positioning node (100) according to any of the claims 19, wherein the positioning node (100) further comprising a handover handler (320) configured to request handover of the terminal (140) to the second radio access network (120) for performing said positioning measurements in the second radio access network (120).

21. A method in a terminal (140) for handling positioning of the terminal (140), wherein the terminal (140) is configured to access a plurality of radio access networks (110, 120, 121) of different access technologies for performing positioning measurements, the terminal (140) being camping on a first radio access network (110), which first radio access network (110) is comprised in the plurality of radio access networks (110, 120, 121) comprising the respective positioning technologies, the plurality of radio access networks further comprising a second radio access network (120), the method comprising:
receiving (1202) a request from a positioning node (100) to perform positioning measurements-according to a positioning method, while involving inter-radio access technology measurements,
performing (1204) positioning measurements at least in the second radio network (120),
transmitting (1205) to the positioning node (100), the positioning measurements comprising at least the measurements performed in the second radio network (120), enabling the positioning node (100) to determine the position of the terminal (140).

22. Method according to claim 21, further comprising:
performing (1203) handover of the terminal (140) to the second radio access network (120), for performing said measurements,
performing (1206) handover of the terminal (140) from the second radio access network (120) back to the first radio access network (110) after said positioning measurements have been performed.

23. Method according to any of the claims 21-22, further comprising:
sending (1201) capabilities to the positioning node (100), which capabilities comprises capabilities related to the respective positioning technologies that the terminal (140) is capable of performing measurements for,
said positioning technologies being available in different radio access network of the plurality of radio access networks (110, 120).

24. Method according to any of the claims 21-23, wherein the measurements in the second radio network (120) comprise measurements in at least one of the GSM, WCDMA, LTE or CDMA 2000 radio access networks.

25. A terminal (140) for handling positioning of the terminal (140), wherein the terminal (140) is configured to access a plurality of radio access networks (110, 120, 121) of different access technologies for performing positioning measurements, the terminal (140) being camping on a first radio access network (110), which first radio access network (110) is comprised in the plurality of radio access networks (110, 120, 121) comprising the respective positioning technologies, the plurality of radio access networks further comprising a second radio access network (120), the terminal (140) comprising:
a receiver (1300) configured to receive a request from a positioning node (100) to perform positioning measurements-according to a positioning method, while involving inter-radio access technology measurements,
a processor (1310) configured to perform positioning measurements at least in the second radio network (120),
a transmitter (1320) configured to transmit the positioning measurements to the positioning node (100), the positioning measurements comprising at least the measurements performed in the second radio network (120), enabling the positioning node (100) to determine the position of the terminal (140).
